(19) United States
(12) Patent Application Publication
(10) Pub. No.: US 2024/0266511 A1
(43) Pub. Date: Aug. 8, 2024

(54) COATING MATERIALS BASED ON UNSATURATED ALIPHATIC HYDROCARBONS AND USES THEREOF IN ELECTROCHEMICAL APPLICATIONS

(71) Applicant: HYDRO-QUÉBEC, Montréal (CA)

(72) Inventors: Benoit FLEUTOT, Boucherville (CA); Emmanuelle GARITTE, Montréal (CA); Charlotte MALLET, Montréal (CA); Nicolas DELAPORTE, Montréal (CA); Marc-André GIRARD, Montréal (CA); Steve DUCHESNE, Montréal (CA)

(21) Appl. No.: 18/565,828

(22) PCT Filed: Jun. 3, 2022
(86) PCT No.: PCT/CA2022/050889

§ 371 Date: Nov. 30, 2023

(30) Foreign Application Priority Data
Jun. 3, 2021 (CA) 3120989

(51) Int. Cl. H01M 4/36; H01M 4/02; H01M 4/131; H01M 4/136; H01M 4/505; H01M 4/525; H01M 4/58; H01M 4/62; H01M 10/0525; H01M 10/0562; H01M 10/0565

(52) U.S. Cl. CPC H01M 4/366; H01M 4/131; H01M 4/136; H01M 4/505; H01M 4/525; H01M 4/5825; H01M 4/622; H01M 4/625; H01M 10/0525; H01M 10/0562; H01M 10/0565; H01M 2004/027; H01M 2004/028; H01M 2300/008; H01M 2300/0082; H01M 2300/0091

(57) ABSTRACT

The present technology relates to a coating material comprising at least one branched or linear unsaturated aliphatic hydrocarbon having from 10 to 50 carbon atoms and having at least one carbon-carbon double or triple bond for use in electrochemical applications, particularly in electrochemical accumulators such as all-solid-state batteries. The present technology also relates to coated particles comprising said coating material and processes of manufacturing the same. Also described are electrode materials, electrodes, electrolytes, current collector coating materials and current collectors comprising said coated particles and their use in electrochemical cells, for example, in electrochemical accumulators, particularly in all-solid-state batteries.

### RELATED APPLICATION

This application claims priority, under applicable law, to Canadian provisional patent application No. 3,120,989 filed on Jun. 3, 2021, the content of which is incorporated herein by reference in its entirety and for all purposes.

### TECHNICAL FIELD

The present application relates to the field of coatings and their use in electrochemical applications. More particularly, the present application relates to coatings for particles of ionically conductive inorganic material, of electrochemically active material, of electronic conductor, to their manufacturing processes and to their uses in electrochemical cells, particularly in all-solid-state-batteries.

### BACKGROUND

All-solid-state electrochemical systems are substantially safer, lighter, more flexible, and more efficient than their counterparts based on the use of liquid electrolytes. However, the field of application for solid electrolytes is still limited.

Indeed, solid polymer electrolytes present problems related to their limited electrochemical stability, their low transport number, and their relatively low ionic conductivity at room temperature.

Ceramic-based solid electrolytes offer a wide window of electrochemical stability and substantially higher ionic conductivity at room temperature. However, they are associated with problems related to their interfacial stability as well as their stability to ambient air and humidity.

Furthermore, the manufacture of solid electrolytes and electrode materials for all-solid-state electrochemical systems very frequently encounter dispersion problems, particularly when forming composite electrodes and electrolytes. More specifically, the nature of the elements of a composite, for example, polymers and inorganic particles, being different, the solid elements may tend to form agglomerates within a polymer matrix or an electrode binder, which may adversely affect the performance, the efficiency, or the stability of the system.

These dispersion problems may also be significantly reduced through the use of binders, additives, or dispersion media that improve particle dispersion.

Examples of dispersion media are described in European patent published under number EP 3 467 845, which are present in the composition of the solid electrolyte.

The manufacture of ceramic-based solid electrolytes is associated with cracking problems following the dry compression process. One strategy employed to solve this problem involves the encapsulation of ceramic-based solid electrolyte particles with a substantially flexible (or elastic) polymer. For example, the Korean patent published under number KR 10-2003300 describes a polymeric coating layer including a polymer based on acrylic, fluorine, diene, silicone, or cellulose applied to the surface of crystalline sulfide-based electrolyte particles. In addition to minimizing the risk of cracking of the solid electrolyte, the polymeric coating layer also allows the aggregation of the electrolyte particles without lowering their ionic conductivity and helps absorb volume variations during cycling. Although this strategy makes it possible to obtain interesting properties, it does not solve the previously mentioned dispersion problems.

Therefore, there is a need for the development of all-solid-state electrochemical systems excluding one or more of the drawbacks of conventional all-solid-state electrochemical systems.

### SUMMARY

According to an aspect, the present technology relates to a coating material comprising at least one branched or linear unsaturated aliphatic hydrocarbon having from 10 to 50 carbon atoms and having at least one carbon-carbon double or triple bond for use in an electrochemical cell.

In one embodiment, the boiling temperature of the unsaturated aliphatic hydrocarbon is above 150° C. For example, the boiling temperature of the unsaturated aliphatic hydrocarbon is in the range of from about 150° C. to about 675° C., or from about 155° C. to about 670° C., or from about 160° C. to about 665° C., or from about 165° C. to about 660° C., or from about 170° C. to about 655° C., upper and lower limits included.

In another embodiment, the unsaturated aliphatic hydrocarbon is selected from the group consisting of decene, dodecene, undecene, tridecene, tetradecene, pentadecene, hexadecene, heptadecene, octadecene, 1,9-decadiene, docosene, hexacosene, eicosene, tetracosene, squalene, farnesene, β-carotene, pinenes, dicyclopentadiene, camphene, α-phellandrene, β-phellandrene, terpinenes, β-myrcene, limonene, 2-carene, sabinene, α-cedrene, copaene, β-cedrene, decyne, dodecyne, octadecyne, hexadecyne, tridecyne, tetradecyne, docosyne, and a combination of at least two thereof. According to a variant of interest, the unsaturated aliphatic hydrocarbon comprises squalene. According to another variant of interest, the unsaturated aliphatic hydrocarbon comprises farnesene. According to another variant of interest, the unsaturated aliphatic hydrocarbon comprises squalene and farnesene.

In another embodiment, the coating material is a mixture comprising the unsaturated aliphatic hydrocarbon and an additional component. For example, the additional component is an alkane or a mixture comprising an alkane and a polar solvent.

According to another aspect, the present technology relates to coated particles for use in an electrochemical cell, said coated particle comprising:
a core comprising an electrochemically active material, an electronically conductive material, or an ionically conductive inorganic material; and
a coating material as defined herein, the coating material being disposed on the surface of the core.

According to another aspect, the present technology relates to a process for manufacturing coated particles as defined herein, the process comprising at least one step of coating at least a part of the surface of the core with the coating material.

In one embodiment, the process further comprises a step of grinding the electrochemically active material, the electronically conductive material, or the ionically conductive inorganic material of the core of the coated particle.

According to another aspect, the present technology relates to an electrode material comprising:
coated particles as defined herein, wherein the core of the coated particle comprises an electrochemically active material; and/or
an electrochemically active material and coated particles as defined herein.

In one embodiment, the core of the coated particle comprises the electrochemically active material. According to an example, the electrochemically active material is selected from a metal oxide, a metal sulfide, a metal oxysulfide, a metal phosphate, a metal fluorophosphate, a metal oxyfluorophosphate, a metal sulfate, a metal halide, a metal fluoride, sulfur, selenium, and a combination of at least two thereof. For example, the metal of the electrochemically active material is selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and a combination of at least two thereof. According to an example, the electrochemically active material further comprises an alkali or alkaline earth metal selected from lithium (Li), sodium (Na), potassium (K), and magnesium (Mg). According to another example, the electrochemically active material is selected from a non-alkali or non-alkaline earth metal, an intermetallic compound, a metal oxide, a metal nitride, a metal phosphide, a metal phosphate, a metal halide, a metal fluoride, a metal sulfide, a metal oxysulfide, carbon, silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and a combination of at least two thereof.

In another embodiment, the electrode material further comprises at least one electronically conductive material. According to a variant of interest, the core of the coated particle comprises the electronically conductive material. For example, the electronically conductive material is selected from the group consisting of carbon black, acetylene black, graphite, graphene, carbon fibers, carbon nanofibers, carbon nanotubes, and a combination of at least two thereof.

In another embodiment, the electrode material further comprises at least one additive. According to a variant of interest, the core of the coated particle comprises the additive. According to an example, the additive is selected from inorganic ionic conductive materials, inorganic materials, glasses, glass-ceramics, ceramics, nano-ceramics, salts, and a combination of at least two thereof. According to another example, the additive comprises ceramic, glass, or glass-ceramic particles based on fluoride, phosphide, sulfide, oxysulfide, or oxide. According to another example, the additive is selected from LISICON, thio-LISICON, argyrodite, garnet, NASICON, perovskite type compounds, oxides, sulfides, oxysulfides, phosphides, fluorides, in crystalline and/or amorphous form, and a combination of at least two thereof. According to another example, the additive is selected from inorganic compounds of formulae MLZO (for example, M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, and M₍₇₋ₐ₎La₃Zr_{(2-b)}Nb_{b}O₁₂); MLTaO (for example, M₇La₃Ta₂O₁₂, M₅La₃Ta₂O₁₂, and M₆La₃Ta_{1.5}Y_{0.5}O₁₂); MLSnO (for example, M₇La₃Sn₂O₁₂); MAGP (for example, M₁₊ₐAlₐGe₂₋ₐ(PO₄)₃); MATP (for example, M₁₊ₐAlₐTi₂₋ₐ(PO₄)₃); MLTiO (for example, M₃ₐLa_{(2/3-a)}TiO₃); MZP (for example, MₐZr_{b}(PO₄)_{c}); MCZP (for example, MₐCa_{b}Zr_{c}(PO₄)_{d}); MGPS (for example, MₐGe_{b}P_{c}S_{d} such as M₁₀GeP₂S₁₂); MGPSO (for example, MₐGe_{b}P_{c}S_{d}Oₑ); MSiPS (for example, MₐSi_{b}P_{c}S_{d} such as M₁₀SiP₂S₁₂); MSiPSO (for example, MₐSi_{b}P_{c}S_{d}Oₑ); MSnPS (for example, MₐSn_{b}P_{c}S_{d} such as M₁₀SnP₂S₁₂); MSnPSO (for example, MₐSn_{b}P_{c}S_{d}Oₑ); MPS (for example, MₐP_{b}S_{c} such as MP₇P₃S₁₁); MPSO (for example, MₐP_{b}S_{c}O_{d}); MZPS (for example, MₐZn_{b}P_{c}S_{d}); MZPSO (for example, MₐZn_{b}P_{c}S_{d}Oₑ); xM₂S-yP₂S₅; xM₂S-yP₂S₅-zMX; xM₂S-yP₂S₅-zP₂O₅; xM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (for example, MₐP_{b}S_{c}X_{d} such as MP₇P₃S₁₁X, M₇P₂S₈X, and M₆PS₅X); MPSOX (for example, MₐP_{b}S_{c}O_{d}Xₑ); MGPSX (for example, MₐGe_{b}P_{c}S_{d}Xₑ); MGPSOX (for example, MₐGe_{b}P_{c}S_{d}OₑX_{f}); MSiPSX (for example, MₐSi_{b}P_{c}S_{d}Xₑ); MSiPSOX (for example, MₐSi_{b}P_{c}S_{d}OₑX_{f}); MSnPSX (for example, MₐSn_{b}P_{c}S_{d}Xₑ); MSnPSOX (for example, MₐSn_{b}P_{c}S_{d}OₑX_{f}); MZPSX (for example, MₐZn_{b}P_{c}S_{d}Xₑ); MZPSOX (for example, MₐZn_{b}P_{c}S_{d}OₑX_{f}); M₃OX; M₂HOX; M₃PO₄; M₃PS₄; and MₐPO_{b}N_{c} (where a=2b+3c−5);

wherein:
M is an alkali metal ion, an alkaline earth metal ion, or a combination thereof, and wherein when M comprises an alkaline earth metal ion, then the number of M is adjusted to achieve electroneutrality;
X is selected from F, Cl, Br, I, or a combination of at least two thereof;
a, b, c, d, e, and f are numbers other than zero and are, independently in each formula, selected to achieve electroneutrality; and
v, w, x, y, and z are numbers other than zero and are, independently in each formula, selected to obtain a stable compound.

According to a variant of interest, the additive is selected from argyrodite-type inorganic compounds of formula Li₆PS₅X, wherein X is Cl, Br, I, or a combination of at least two thereof. For example, the additive is Li₆PS₅Cl.

According to another aspect, the present technology relates to an electrode comprising the electrode material as defined herein on a current collector. According to another aspect, the present technology relates to a self-supported electrode comprising the electrode material as defined herein. In one embodiment, said electrode is a positive electrode.

According to another aspect, the present technology relates to an electrolyte comprising coated particles as defined herein, wherein the core of the coated particle comprises an ionically conductive inorganic material. According to an example, the ionically conductive inorganic material is selected from glasses, glass-ceramics, ceramics, nano-ceramics, and a combination of at least two thereof. According to another example, the ionically conductive inorganic material comprises ceramic, glass, or glass-ceramic particles based on fluoride, phosphide, sulfide, oxysulfide, or oxide. According to another example, the ionically conductive inorganic material is selected from LISICON, thio-LISICON, argyrodite, garnet, NASICON, perovskite type compounds, oxides, sulfides, oxysulfides, phosphides, fluorides, in crystalline and/or amorphous form, and a combination of at least two thereof. According to another example, the ionically conductive inorganic material is selected from inorganic compounds of formulae MLZO (for example, M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, and M₍₇₋ₐ₎La₃Zr_{(2-b)}Nb_{b}O₁₂); MLTaO (for example, M₇La₃Ta₂O₁₂, M₅La₃Ta₂O₁₂, and M₆La₃ Ta_{1.5}Y_{0.5}O₁₂); MLSnO (for example, M₇La₃Sn₂O₁₂); MAGP (for example, M₁₊ₐAlₐGe₂₋ₐ(PO₄)₃); MATP (for example, M₁₊ₐAlₐTi₂₋ₐ(PO₄)₃); MLTiO (for example, M₃ₐLa_{(2/3-a)}TiO₃); MZP (for example, MₐZr_{b}(PO₄)_{c}); MCZP (for example, MₐCa_{b}Zr_{c}(PO₄)_{d}); MGPS (for example, MₐGe_{b}P_{c}S_{d} such as M₁₀GeP₂S₁₂); MGPSO (for example, MₐGe_{b}P_{c}S_{d}Oₑ); MSiPS (for example, MₐSi_{b}P_{c}S_{d} such as M₁₀SiP₂S₁₂); MSiPSO (for example, MₐSi_{b}P_{c}S_{d}Oₑ); MSnPS (for example, MₐSn_{b}P_{c}S_{d} such as M₁₀SnP₂S₁₂); MSnPSO (for example, MₐSn_{b}P_{c}S_{d}Oₑ); MPS (for example, MₐP_{b}S_{c} such as M₇P₃S₁₁); MPSO (for example, MₐP_{b}S_{c}O_{d}); MZPS (for example, MₐZn_{b}P_{c}S_{d}); MZPSO (for example, MₐZn_{b}P_{c}S_{d}Oₑ); xM₂S-yP₂S₅; xM₂S-yP₂S₅-zMX; xM₂S-yP₂S₅-zP₂O₅; xM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (for example, MₐP_{b}S_{c}X_{d} such as M₇P₃S₁₁X, M₇P₂S₈X, and M₆PS₅X); MPSOX (for example, MₐP_{b}S_{c}O_{d}Xₑ); MGPSX (for example, MₐGe_{b}P_{c}S_{d}Xₑ); MGPSOX (for example, MₐGe_{b}P_{c}S_{d}OₑX_{f}); MSiPSX (for example, MₐSi_{b}P_{c}S_{d}Xₑ); MSiPSOX (for example, MₐSi_{b}P_{c}S_{d}OₑX_{f}); MSnPSX (for example, MₐSn_{b}P_{c}S_{d}Xₑ); MSnPSOX (for example, MₐSn_{b}P_{c}S_{d}OₑX_{f}); MZPSX (for example, MₐZn_{b}P_{c}S_{d}Xₑ); MZPSOX (for example, MₐZn_{b}P_{c}S_{d}OₑX_{f}); M₃OX; M₂HOX; M₃PO₄; M₃PS₄; and MₐPO_{b}N_{c} (where a=2b+3c−5);

wherein:
M is an alkali metal ion, an alkaline earth metal ion, or a combination thereof, and wherein when M comprises an alkaline earth metal ion, then the number of M is adjusted to achieve electroneutrality;
X is selected from F, Cl, Br, I, or a combination of at least two thereof;
a, b, c, d, e, and f are numbers other than zero and are, independently in each formula, selected to achieve electroneutrality; and
v, w, x, y, and z are numbers other than zero and are, independently in each formula, selected to obtain a stable compound.

According to a variant of interest, the ionically conductive inorganic material is selected from argyrodite-type inorganic compounds of formula Li₆PS₅X, wherein X is Cl, Br, I, or a combination of at least two thereof. For example, the ionically conductive inorganic material is Li₆PS₅Cl.

According to another aspect, the present technology relates to a coating material for a current collector comprising coated particles as defined herein, wherein the core of the coated particle comprises an electronically conductive material. For example, the electronically conductive material is carbon.

According to another aspect, the present technology relates to a current collector comprising a coating material as defined herein, disposed on a metal foil.

According to another aspect, the present technology relates to an electrochemical cell comprising a negative electrode, a positive electrode, and an electrolyte, wherein at least one of the positive electrode or the negative electrode is as defined herein or comprises an electrode material as defined herein.

According to another aspect, the present technology relates to an electrochemical cell comprising a negative electrode, a positive electrode, and an electrolyte, wherein the electrolyte is as defined herein.

According to another aspect, the present technology relates to an electrochemical cell comprising a negative electrode, a positive electrode, and an electrolyte, wherein at least one of the positive electrode and the negative electrode is on a current collector as defined herein or comprising a coating material as defined herein.

According to another aspect, the present technology relates to an electrochemical accumulator comprising at least one electrochemical cell as defined herein.

In one embodiment, the electrochemical accumulator is a battery selected from a lithium battery, a lithium-ion battery, a sodium battery, a sodium-ion battery, a magnesium battery, and a magnesium-ion battery.

In another embodiment, the electrochemical accumulator is an all-solid-state battery.

### BRIEF DESCRIPTION OF THE FIGURES

FIG. 1 shows images obtained by scanning electron microscopy (SEM) in (A) of Li₆PS₅Cl particles before the grinding and coating step, in and (B) of Li₆PS₅Cl particles coated with a mixture of decane and squalene, as described in Example 3(a).

FIG. 2 presents thermogravimetric analysis results for squalene (♦; curve 1) and for Li₆PS₅Cl particles coated with a mixture of decane and squalene (○; curve 2), as described in Example 3(b).

FIG. 3 presents respectively in (A) and (B) proton nuclear magnetic resonance (¹H NMR) and carbon nuclear magnetic resonance (¹³C NMR) spectra obtained for Li₆PS₅Cl particles coated with a mixture of decane and squalene, as described in Example 3(c).

FIG. 4 presents proton nuclear magnetic resonance (1H NMR) spectra obtained for pure farnesene as well as for Li₆PS₅Cl particles coated with a mixture of decane and farnesene, as described in Example 3(c).

FIG. 5 presents proton nuclear magnetic resonance (¹H NMR) spectra obtained for pure farnesene and squalene as well as for Li₆PS₅Cl particles coated with a mixture of decane, squalene, and farnesene, as described in Example 3(c).

FIG. 6 shows in (A) and (B) images obtained by SEM and energy dispersive X-ray spectroscopy (EDS) Ni and S element mapping images obtained respectively for Films 1 and 2, as described in Example 4(b).

FIG. 7 shows (A) and (B) images obtained by backscattered electron SEM and enlargements of these images respectively for Films 3 and 4, as described in Example 4(b).

FIG. 8 shows in (A) a graph of the discharge capacity (mAh/g) and the coulombic efficiency (%) as a function of the number of cycles, and in (B) a graph of the average charge and discharge potential (V) as a function of the number of cycles for Cell 1 (▴) and for Cell 2 (▪), as described in Example 5(b).

FIG. 9 shows in (A) a graph of the discharge capacity and the coulombic efficiency as a function of the number of cycles, and in (B) a graph of the average charge and discharge potential (V) as a function of the number of cycles for Cell 2 (▪), Cell 3 (▾), Cell 4 (▴), and Cell 5 (●), as described in Example 5(b).

FIG. 10 shows a graph of the discharge capacity and the coulombic efficiency as a function of the number of cycles for Cell 2 (▪), Cell 6 ( [symbol] ), and Cell 7 (★), as described in Example 5(b).

FIG. 11 shows proton nuclear magnetic resonance (¹H NMR) spectra for Film 4 samples in solution before cycling (blue) and after cycling (red), as described in Example 6(a).

FIG. 12 shows a graph of the amount of hydrogen sulfide (H₂S) gas generated (mL/g) as a function of time (hours) for a Li₆PS₅Cl powder coated with decane (dashed line), coated with a decane: squalene mixture (85:15 by volume) (dash-dot-dot line), and coated with a decane: squalene mixture (75:25 by volume) (solid line), as described in Example 6(b).

### DETAILED DESCRIPTION

All technical and scientific terms and expressions used herein have the same definitions as those generally understood by the person skilled in the art of the present technology. The definition of some terms and expressions used is nevertheless provided below.

When the term “about” is used herein, it means approximately, in the region of, or around. For example, when the term “about” is used in relation to a numerical value, it modifies it above and below by a variation of 10% from its nominal value. This term may also take into account, for example, the experimental error of a measuring device or rounding.

When a range of values is mentioned in the present application, the lower and upper limits of the range are, unless otherwise indicated, always included in the definition. When a range of values is mentioned in the present application, then all intermediate ranges and sub-ranges, as well as the individual values included in the ranges of values, are included in the definition.

When the article “a” is used to introduce an element in the present application, it does not have the meaning of “one only”, but rather of “one or more”. Of course, where the description states that a particular step, component, element, or feature “may” or “could” be included, that particular step, component, element, or feature is not required to be included in each embodiment.

The chemical structures described herein are drawn according to the conventions of the field. Also, when an atom, such as a carbon atom, as drawn appears to include an incomplete valence, then the valence is assumed to be satisfied by one or more hydrogen atoms even if they are not explicitly drawn.

The present technology relates to a coating material comprising at least one branched or linear unsaturated aliphatic hydrocarbon having from 10 to 50 carbon atoms and having at least one carbon-carbon double or triple bond for use in an electrochemical cell.

According to an example, the unsaturated aliphatic hydrocarbon as defined herein is characterized by a boiling temperature above about 150° C. For example, the unsaturated aliphatic hydrocarbon is characterized by a boiling temperature in the range of from about 150° C. to about 675° C., or from about 155° C. to about 670° C., or from about 160° C. to about 665° C., or from about 165° C. to about 660° C., or from about 170° C. to about 655° C., upper and lower limits included.

According to another example, the unsaturated aliphatic hydrocarbon as defined herein includes a single carbon-carbon double or triple bond, for example, an alkene, an alkyne, or an acyclic olefin. Alternatively, the unsaturated aliphatic hydrocarbon includes at least two conjugated or non-conjugated carbon-carbon double bonds, for example, an alkadiene, an alkatriene, and so on, or a polyene. Alternatively, the unsaturated aliphatic hydrocarbon includes at least two carbon-carbon triple bonds, for example, an alkadiyne, an alkatriyne, and so on, or a polyyne. Alternatively, the unsaturated aliphatic hydrocarbon includes at least one carbon-carbon double bond and at least one carbon-carbon triple bond.

Non-limiting examples of unsaturated aliphatic hydrocarbons having at least one carbon-carbon double bond as defined herein include decene, dodecene, undecene, tridecene, tetradecene, pentadecene, hexadecene, heptadecene, octadecene, 1,9-decadiene, docosene, hexacosene, eicosene, tetracosene, squalene, farnesene, β-carotene, pinenes, dicyclopentadiene, camphene, α-phellandrene, β-phellandrene, terpinenes, β-myrcene, limonene, 2-carene, sabinene, α-cedrene, copaene, β-cedrene, and combinations thereof. According to an example, the unsaturated aliphatic hydrocarbon is selected from decene, dodecene, undecene, tridecene, tetradecene, pentadecene, hexadecene, heptadecene, octadecene, 1,9-decadiene, docosene, hexacosene, eicosene, tetracosene, squalene, β-carotene, and combinations thereof. According to another example, the unsaturated aliphatic hydrocarbon is selected from decene, undecene, squalene, octadecene, β-carotene, and a combination of at least two thereof. According to a variant of interest, the unsaturated aliphatic hydrocarbon includes squalene. According to another variant of interest, the unsaturated aliphatic hydrocarbon includes farnesene. According to another variant of interest, the unsaturated aliphatic hydrocarbon includes a mixture including squalene and farnesene.

Non-limiting examples of unsaturated aliphatic hydrocarbons having at least one carbon-carbon triple bond as defined herein include decyne, dodecyne, octadecyne, hexadecyne, tridecyne, tetradecyne, docosyne, and a combination of at least two thereof. According to another example, the coating material as defined herein is a mixture comprising the unsaturated aliphatic hydrocarbon as defined herein and at least one additional component. According to an example, the additional component may be an alkane, for example, an alkane having from 10 to 50 carbon atoms. According to another example, the additional component may be a mixture comprising an alkane as defined herein and a polar solvent. Non-limiting examples of polar solvents include tetrahydrofuran, acetonitrile, N, N-dimethylformamide, and a miscible combination of at least two thereof. According to a variant of interest, the additional component is decane.

The present technology also relates to coated particles for use in an electrochemical cell. More particularly, the coated particles comprise:
a core comprising an electrochemically active material, an electronically conductive material, or an ionically conductive inorganic material; and
a coating material as defined herein disposed on the surface of said core.

According to an example, the coating material may form a homogeneous coating layer on the surface of the core. That is, it may form a substantially uniform coating layer on the surface of the core.

According to another example, the coating material may form a coating layer over at least part of the surface of the core. In other words, it may be heterogeneously dispersed on the surface of the core.

It must be understood that the volume or mass ratio of the coating material and the material of said core, as well as the conditions of the coating process, influence the degree of coverage of the surface of said core by the coating material and/or the homogeneity of the coated particle samples.

The use of coated particles as defined herein in electrochemical applications is also contemplated. According to an example, coated particles may be used in electrochemical cells, electrochemical accumulators, particularly in all-solid-state batteries. For example, the coated particles may be used in an electrode material, in an electrolyte, or at the interface between the two as an additional layer.

The present technology also relates to a process for manufacturing coated particles as defined herein, the process comprising at least one step of coating at least a part of the surface of the core with the coating material. The coating step may be carried out by any compatible coating method. For example, the coating step may be carried out by a dry or a wet coating process. According to a variant of interest, the coating step may be carried out by a wet coating process, for example, by a mechanical coating process, such as a mixing, grinding, or mechanosynthesis process.

According to an example, the process further comprises a step of grinding (or pulverizing) the electrochemically active material, the electronically conductive material, or the ionically conductive inorganic material of said core of the coated particle. For example, the coating and milling steps may be carried out simultaneously, sequentially, or may partially overlap in time. When the coating and milling steps are performed sequentially, the milling step may be performed before the coating step. According to a variant of interest, the coating and grinding steps are carried out simultaneously, for example, using a planetary mill or a planetary micro mill.

According to another example, the coating and milling steps may be carried out at a rotation speed and for a set time to achieve an optimum particle size or diameter, a desired degree of coverage of the surface of the core of the particle by the coating material, and/or a desired homogeneity of the coated particle samples.

According to some examples, the particles are sulfide-based ceramic particles (for example, Li₆PS₅Cl argyrodite particles). The coating and grinding steps are carried out at a rotational speed of about 300 rpm for about 7.5 hours to obtain coated Li₆PS₅Cl particles with a final particle size of less than or equal to about 1 μm.

According to another example, the process further comprises a step of drying the coated particles. According to an example, the drying step may be carried out to remove moisture and/or residual solvent. According to another example, the drying process may be carried out at low temperature and for a set time in order to dry the coated particles, without evaporating the coating material or without evaporating the coating material significantly. For example, the drying step may be carried out at a temperature below the boiling temperature of the unsaturated aliphatic hydrocarbon of the coating material, and for a set time so as not to evaporate it or not to evaporate it significantly. It is understood that, when the coating material comprises a mixture, at least one unsaturated aliphatic hydrocarbon does not evaporate entirely during the drying step, and therefore remains present in the coating layer disposed on the surface of the core of the particle. For example, when the mixture comprises an additional component (for example, an alkane or a mixture comprising an alkane and a polar solvent as defined above), this may be partially or completely evaporated during the drying step. According to an example, the drying step may be carried out at a temperature of about 80° C. for a duration of about 5 hours.

According to another example, when the coating material comprises a mixture, the composition of said mixture comprises at least about 2% by volume of the unsaturated aliphatic hydrocarbon as defined herein, during the coating step. For example, the composition of said mixture comprises at least about 3%, or at least about 4%, or at least about 5% by volume of the unsaturated aliphatic hydrocarbon as defined herein, during the coating step.

According to another example, the process further comprises a step of coating (also called spreading) a suspension comprising said coated particles, said coating step being carried out, for example, by at least one of a doctor blade coating method, a comma coating method, a reverse-comma coating method, a printing method such as a gravure coating, or a slot-die coating method. According to a variant of interest, said coating step is performed by a doctor blade coating method. According to an example, the suspension comprising said coated particles may be coated onto a supporting substrate or film, said supporting substrate or film being subsequently removed. According to another example, the suspension comprising said particles may be coated directly onto a current collector.

The present technology also relates to an electrode material comprising:
coated particles as defined herein, wherein the core comprises an electrochemically active material; and/or
an electrochemically active material and coated particles as defined herein.

According to another example, said electrode material is a positive electrode material and the electrochemically active material is selected from a metal oxide, a metal sulfide, a metal oxysulfide, a metal phosphate, a metal fluorophosphate, a metal oxyfluorophosphate, a metal sulfate, a metal halide (for example, a metal fluoride), sulfur, selenium, and a combination of at least two thereof. According to another example, the metal of the electrochemically active material is selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and combinations thereof, when compatible. The electrochemically active material may optionally further comprise an alkali or alkaline earth metal, for example, lithium (Li), sodium (Na), potassium (K), or magnesium (Mg).

Non-limiting examples of electrochemically active materials include lithium metal phosphates, complex oxides, such as LiM′PO₄ (where M″ is Fe, Ni, Mn, Co, or a combination thereof), LiV₃O₈, V₂O₅, LiMn₂O₄, LiM″O₂ (where M″ is Mn, Co, Ni, or a combination thereof), Li(NiM″′)O₂ (where M″′ is Mn, Co, Al, Fe, Cr, Ti, or Zr, or a combination thereof), and combinations thereof, when compatible.

According to an example of interest, the electrochemically active material is an oxide, or a phosphate as described above.

For example, the electrochemically active material is a lithium manganese oxide, wherein manganese may be partially substituted with a second transition metal, such as lithium nickel manganese cobalt oxide (NMC). According to an alternative, the electrochemically active material is lithiated iron phosphate. According to another alternative, the electrochemically active material is a manganese-containing lithiated metal phosphate such as those described above, for example, the manganese-containing lithiated metal phosphate is a lithiated iron and manganese phosphate (LiMn₁₋ₓFeₓPO₄, where x is between 0.2 and 0.5).

According to another example, said electrode material is a negative electrode material and the electrochemically active material is selected from a non-alkali and non-alkaline earth metal (for example, indium (In), germanium (Ge), and bismuth (Bi)), an intermetallic compound (for example, SnSb, TiSnSb, Cu₂Sb, AlSb, FeSb₂, FeSn₂, and CoSn₂), a metal oxide, a metal nitride, a metal phosphide, a metal phosphate (for example, LiTi₂(PO₄)₃), a metal halide (for example, a metal fluoride), a metal sulfide, a metal oxysulfide, a carbon (for example, graphite, graphene, reduced graphene oxide, hard carbon, soft carbon, exfoliated graphite, and amorphous carbon), silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and their combinations, when compatible. For example, the metal oxide may be selected from compounds of formulae M″″_{b}O_{c} (where M″″ is Ti, Mo, Mn, Ni, Co, Cu, V, Fe, Zn, Nb, or a combination thereof; and b and c are numbers such that the ratio c:b is in the range of from 2 to 3) (for example, MoO₃, MoO₂, MoS₂, V₂O₅, and TiNb₂O₇), spinel oxides (for example, NiCo₂O₄, ZnCo₂O₄, MnCo₂O₄, CuCo₂O₄, and CoFe₂O₄), and LiM″″′O (where M″″′ is Ti, Mo, Mn, Ni, Co, Cu, V, Fe, Zn, Nb, or a combination of at least two thereof) (for example, a lithium titanate (such as Li₄Ti₅O12) or a lithium molybdenum oxide (such as Li₂MO₄O₁₃)).

According to another example, the electrochemically active material may optionally be doped with other included elements in smaller amounts, for example, to modulate or optimize its electrochemical properties. The electrochemically active material may be doped by partial substitution of the metal with other ions. For example, the electrochemically active material may be doped with a transition metal (for example, Ti, V, Cr, Mn, Fe, Co, Ni, Cu, Zn, or Y) and/or a metal other than a transition metal (for example, Mg, Al, or Sb).

According to another example, the electrochemically active material may be in the form of particles (for example, microparticles and/or nanoparticles) which may be freshly formed or from a commercial source. For example, an embedding material forms an embedding layer on the surface of the electrochemically active material and the coating material is disposed on the surface of the embedding layer. For example, the electrochemically active material may be in the form of particles covered with a layer of embedding material. The embedding material may be an electronically conductive material, for example, a conductive carbon embedding. Alternatively, the embedding material may allow to substantially reduce the interfacial reactions at the interface between the electrochemically active material and an electrolyte, for example, a solid electrolyte, and in particular, an inorganic ceramic-type solid electrolyte based on sulfide (for example, based on Li₆PS₅Cl). For example, the embedding material may be selected from Li₂SiO₃, LiTaO₃, LiAlO₂, Li₂O-ZrO₂, LiNbO₃, their combinations, when compatible, and other similar materials. According to a variant of interest, the embedding material comprises LiNbO₃.

According to another example, the electrode material as defined herein further includes a conductive material. According to a variant of interest, the core of the coated particle comprises the electronically conductive material.

Non-limiting examples of electronically conductive materials include a carbon source such as carbon black (for example, Ketjen™ carbon and Super P™ carbon), acetylene black (for example, Shawinigan carbon and Denka™ carbon black), graphite, graphene, carbon fibers (for example, vapor grown carbon fibers (VGCFs)), carbon nanofibers, carbon nanotubes (CNTs), and a combination of at least two thereof.

According to another example, the electronically conductive material, if it is present in the electrode material, may be a modified electronically conductive material such as those described in the PCT patent application published under number WO2019/218067 (Delaporte et al.). For example, the modified electronically conductive material may be grafted with at least one aryl group of Formula I:

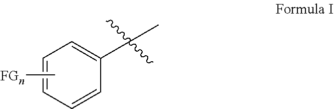

wherein:
FG is a hydrophilic functional group; and
n is an integer in the range of from 1 to 5, preferably n is in the range of from 1 to 3, preferably n is 1 or 2, or more preferably n is 1.

Examples of hydrophilic functional groups include hydroxyl, carboxyl, sulfonic acid, phosphonic acid, amine, amide, and other similar groups. For example, the hydrophilic functional group is a carboxyl or sulfonic acid functional group. The functional group may optionally be lithiated by the exchange of a hydrogen with a lithium. Preferred examples of aryl groups of Formula I are p-benzoic acid or p-benzenesulfonic acid.

According to a variant of interest, the electronically conductive material is carbon black optionally grafted with at least one aryl group of Formula I. According to another variant of interest, the electronically conductive material may be a mixture comprising at least one modified electronically conductive material. For example, a mixture of carbon black grafted with at least one aryl group of Formula I and carbon fibers (for example, vapor grown carbon fibers (VGCFs)), carbon nanofibers, carbon nanotubes (CNTs), or a combination of at least two thereof.

According to another example, the electrode material as defined herein further includes an additive. For example, the core of the coated particle comprises the additive. For example, the additive is selected from inorganic ionic conductive materials, inorganic materials, glasses, glass-ceramics, ceramics, including nano-ceramics (for example, Al₂O₃, TiO₂, SiO₂, and other similar compounds), salts (for example, lithium salts), and a combination of at least two thereof. For example, the additive may be an inorganic ionic conductor selected from LISICON, thio-LISICON, argyrodite, garnet, NASICON, perovskite type compounds, oxides, sulfides, phosphides, fluorides, sulfur halides, phosphates, thio-phosphates, in crystalline and/or amorphous form, and a combination of at least two thereof.

According to a variant of interest, the additive, if present in the electrode material, may be ceramic, glass, or glass-ceramic particles based on fluoride, phosphide, sulfide, oxysulfide, oxide, or a combination of at least two thereof. Non-limiting examples of ceramic, glass, or glass-ceramic particles include inorganic compounds of formulae MLZO (for example, M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, and M₍₇₋ₐ₎La₃Zr_{(2-b)}Nb_{b}O₁₂); MLTaO (for example, M₇La₃Ta₂O₁₂, M₅La₃Ta₂O₁₂, and M₆La₃ Ta_{1.5}Y_{0.5}O₁₂); MLSnO (for example, M₇La₃Sn₂O₁₂); MAGP (for example, M₁₊ₐAlₐGe₂₋ₐ(PO₄)₃); MATP (for example, M₁₊ₐAlₐTi₂₋ₐ(PO₄)₃); MLTiO (for example, M₃ₐLa_{(2/3-a)}TiO₃); MZP (for example, MₐZr_{b}(PO₄)_{c}); MCZP (for example, MₐCa_{b}Zr_{c}(PO₄)_{d}); MGPS (for example, MₐGe_{b}P_{c}S_{d} such as M₁₀GeP₂S₁₂); MGPSO (for example, MₐGe_{b}P_{c}S_{d}Oₑ); MSiPS (for example, MₐSi_{b}P_{c}S_{d} such as M₁₀SiP₂S₁₂); MSiPSO (for example, MₐSi_{b}P_{c}S_{d}Oₑ); MSnPS (for example, MₐSn_{b}P_{c}S_{d} such as M₁₀SnP₂S₁₂); MSnPSO (for example, MₐSn_{b}P_{c}S_{d}Oₑ); MPS (for example, MₐP_{b}S_{c} such as M₇P₃S₁₁); MPSO (for example, MₐP_{b}S_{c}O_{d}); MZPS (for example, MₐZn_{b}P_{c}S_{d}); MZPSO (for example, MₐZn_{b}P_{c}S_{d}Oₑ); xM₂S-yP₂S₅; xM₂S-yP₂S₅-zMX; xM₂S-yP₂S₅-zP₂O₅; xM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (for example, MₐP_{b}S_{c}X_{d}such as M₇P₃S₁₁X, M₇P₂S₈X, and M₆PS₅X (such as Li₆PS₅Cl)); MPSOX (for example, MₐP_{b}S_{c}O_{d}Xₑ); MGPSX (for example, MₐGe_{b}P_{c}S_{d}Xₑ); MGPSOX (for example, MₐGe_{b}P_{c}S_{d}OₑX_{f}); MSiPSX (for example, MₐSi_{b}P_{c}S_{d}Xₑ); MSiPSOX (for example, MₐSi_{b}P_{c}S_{d}OₑX_{f}); MSnPSX (for example, MₐSn_{b}P_{c}S_{d}Xₑ); MSnPSOX (for example, MₐSn_{b}P_{c}S_{d}OₑX_{f}); MZPSX (for example, MₐZn_{b}P_{c}S_{d}Xₑ); MZPSOX (for example, MₐZn_{b}P_{c}S_{d}OₑX_{f}); M₃OX; M₂HOX; M₃PO₄; M₃PS₄; and MₐPO_{b}N_{c} (where a=2b+3c−5);

wherein:
M is an alkali metal ion, an alkaline earth metal ion, or a combination thereof, and wherein when M comprises an alkaline earth metal ion, then the number of M is adjusted to achieve electroneutrality;
X is selected from F, Cl, Br, I, or a combination of at least two thereof;
a, b, c, d, e, and f are numbers other than zero and are, independently in each formula, selected to achieve electroneutrality; and
v, w, x, y, and z are numbers other than zero and are, independently in each formula, selected to obtain a stable compound.

For example, M is selected from Li, Na, K, Rb, Cs, Be, Mg, Ca, Sr, Ba, or a combination of at least two thereof. According to a variant of interest, M comprises Li and may further comprise at least one of Na, K, Rb, Cs, Be, Mg, Ca, Sr, Ba, or a combination of at least two thereof. According to a variant of interest, M comprises Na, K, Mg, or a combination of at least two thereof.

For example, the additive, if it is present in the electrode material, may be sulfide-based ceramic particles, for example, argyrodite-type ceramic particles of formula Li₆PS₅X (where X is Cl, Br, I, or a combination of at least two thereof). According to a variant of interest, the additive is argyrodite Li₆PS₅Cl.

According to another example, the electrode material as defined herein further includes a binder. For example, the binder is selected for its compatibility with the various elements of an electrochemical cell. Any known compatible binder is contemplated. For example, the binder may be selected from a polymer binder of the polyether, polycarbonate or polyester type, a fluorinated polymer, and a water-soluble binder. According to an example, the binder is a fluorinated polymer such as polyvinylidene fluoride (PVDF) or polytetrafluoroethylene (PTFE). According to another example, the binder is a water-soluble binder such as styrene-butadiene rubber (SBR), acrylonitrile-butadiene rubber (NBR), hydrogenated NBR (HNBR), epichlorohydrin rubber (CHR), or acrylate rubber (ACM), and optionally comprising a thickening agent such as carboxymethylcellulose (CMC), or a polymer such as poly(acrylic acid) (PAA), poly(methyl methacrylate) (PMMA), or a combination of at least two thereof. According to another example, the binder is a polymer binder of the polyether type. For example, the polymer binder of the polyether type is linear, branched and/or crosslinked and is based on poly(ethylene oxide) (PEO), poly(propylene oxide) (PPO), or a combination of the two (such as an EO/PO copolymer), and optionally comprises crosslinkable units. For example, the crosslinkable segment of the polymer may be a polymer segment comprising at least one functional group that is crosslinkable multi-dimensionally by irradiation or thermal treatment.

According to a variant of interest, the binder, if present in the electrode material, may comprise a blend including a polybutadiene-based polymer and a polymer comprising norbornene-based monomer units derived from the polymerization of a compound of Formula II:

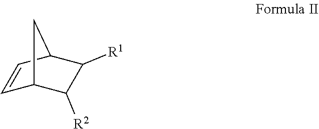

wherein,
R¹ and R² are independently and in each occurrence selected from a hydrogen atom, a carboxyl group (—COOH), a sulfonic acid group (—SO₃H), a hydroxyl group (—OH), a fluorine atom, and a chlorine atom.

According to an example, at least one of R¹ or R² is selected from —COOH, —SO₃H, —OH, —F, and —Cl, which means that at least one of R¹ or R² is different from a hydrogen atom.

According to another example, R¹ is a —COOH group and R² is a hydrogen atom.

According to another example, at least one of R¹ or R² is a —COOH group and the norbornene-based monomer units are carboxylic acid-functionalized norbornene-based monomer units. According to a variant of interest, R¹ is a —COOH group and R² is a hydrogen atom. According to another variant of interest, R¹ and R² are both —COOH groups.

According to another variant of interest, the binder, if present in the electrode material, may comprise a blend including a polybutadiene-based polymer and a polymer of Formula III:

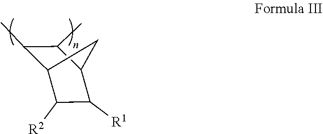

wherein,
R¹ and R² are as defined above, and n is an integer selected so that the mass average molecular weight of the polymer of Formula III is between about 10 000 g/mol and about 100 000 g/mol as determined by gel permeation chromatography (GPC), upper and lower limits included.

According to another example, the mass average molecular weight of the polymer of Formula III is between about 12 000 g/mol and about 85 000 g/mol, or between about 15 000 g/mol and about 75 000 g/mol, or between about 20 000 g/mol and about 65 000 g/mol, or between about 25 000 g/mol and about 55 000 g/mol, or between about 25 000 g/mol and about 50 000 g/mol as determined by GPC, upper and lower limits included. According to a variant of interest, R¹ and R² are —COOH groups.

According to an example, the polymer is of Formula III(a):

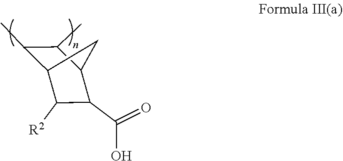

wherein,
R² and n are as defined above.

According to another example, the polymer is of Formula III(b):

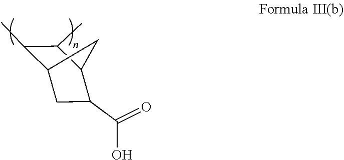

wherein,
n is as defined above.

According to another example, the norbornene-based polymer of Formula II, or the polymer of Formula III, III(a), or III(b) is a homopolymer.

According to another example, the polymerization of the norbornene-based monomer of Formula II may be carried out by any known compatible polymerization method. According to a variant of interest, the polymerization of the compound of Formula II may be carried out by the synthesis process described by Commarieu, B. et al. (Commarieu, Basile, et al. “Ultrahigh T_{g} Epoxy Thermosets Based on Insertion Polynorbornenes”, Macromolecules, 49.3 (2016): 920-925). For example, the polymerization of the compound of Formula II may also be carried out by an addition polymerization process.

For example, norbornene-based polymers produced by an addition polymerization process are substantially stable under severe conditions (for example, acidic and basic conditions). The addition polymerization of norbornene-based polymers may be carried out using inexpensive norbornene-based monomers. The glass transition temperature (T_{g}) obtained with norbornene-based polymers produced by this polymerization route may be equal to or higher than about 300° C., for example, as high as 350° C.

According to another example, the polybutadiene-based polymer may be characterized by substantially higher elasticity or flexibility and/or substantially lower glass transition temperature (T_{g}) than those of the norbornene-based polymer of Formulae III, III(a), or III(b).

According to another example, the polybutadiene-based polymer may be polybutadiene. Alternatively, the polybutadiene-based polymer may be functionalized polybutadiene or a polybutadiene-derived polymer. For example, in comparison with non-functionalized polybutadiene, the functionalized polybutadiene or polybutadiene-derived polymer may be characterized by substantially higher elasticity or flexibility, and/or substantially lower glass transition temperature (T_{g}) and/or may improve the mechanical or cohesive properties of the electrode binder.

According to another example, the polybutadiene-based polymer is selected from epoxidized polybutadienes, for example, epoxidized polybutadienes having reactive end groups. For example, the reactive end groups may be hydroxyl groups. The epoxidized polybutadiene may comprise repeating units of Formulae IV, V, and VI:

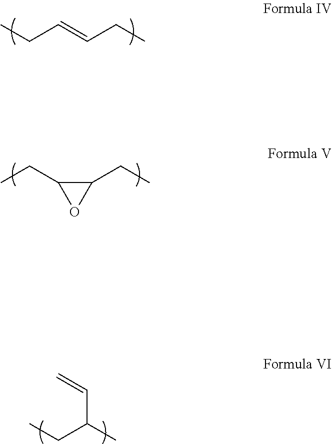

and two hydroxyl end groups.

According to another example, the mass average molecular weight of the epoxidized polybutadiene comprising repeating units of Formulae IV, V, and VI may be between about 1 000 g/mol and about 1 500 g/mol as determined by GPC, upper and lower limits included.

According to another example, the epoxide equivalent weight of the epoxidized polybutadiene comprising repeating units of Formulae IV, V, and VI is between about 100 g/mol and about 600 g/mol as determined by GPC, upper and lower limits included. The epoxide equivalent weight corresponds to the mass of resin containing 1 mol of epoxide functional groups.

According to a variant of interest, the epoxidized polybutadiene is of Formula VII:

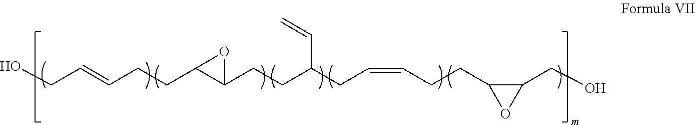

wherein,
m is an integer selected so that the mass average molecular weight of the epoxidized polybutadiene of Formula VII is between about 1 000 g/mol and about 1 500 g/mol as determined by GPC, upper and lower limits included; and
the epoxide equivalent weight is between about 100 g/mol and about 600 g/mol as determined by GPC, upper and lower limits included.

According to another example, the mass average molecular weight of the epoxidized polybutadiene comprising repeating units of Formulae IV, V, and VI or the epoxidized polybutadiene of Formula VII is between about 1 050 g/mol and about 1 450 g/mol, or between about 1 100 g/mol and about 1 400 g/mol, or between about 1 150 g/mol and about 1 350 g/mol, or between about 1 200 g/mol and about 1 350 g/mol, or between about 1 250 g/mol and about 1 350 g/mol, as determined by GPC, upper and lower limits included. According to a variant of interest, the mass average molecular weight of the epoxidized polybutadiene comprising repeating units of Formulae IV, V, and VI or of the epoxidized polybutadiene of Formula VII is about 1 300 g/mol, as determined by GPC.

According to another example, the epoxide equivalent weight of the epoxidized polybutadiene comprising repeating units of Formulae IV, V, and VI or of the epoxidized polybutadiene of Formula VII is between about 150 g/mol and about 550 g/mol, or between about 200 g/mol and about 550 g/mol, or between about 210 g/mol and about 550 g/mol, or between about 260 g/mol and about 500 g/mol, as determined by GPC, upper and lower limits included. According to a variant of interest, the epoxide equivalent weight of the epoxidized polybutadiene comprising repeating units of Formulae IV, V, and VI or of the epoxidized polybutadiene of Formula VII is between about 400 g/mol and about 500 g/mol, or between about 260 g/mol and about 330 g/mol as determined by GPC, upper and lower limits included.

For example, the epoxidized polybutadiene of Formula VII is a commercial hydroxyl-terminated epoxidized polybutadiene resin of the Poly bd™ 600E or 605E type marketed by Cray Valley. The physicochemical properties of these resins are presented in Table 1.

TABLE 1
Physical and chemical properties of
Poly bd 600E and 605E type resins

| Property | Poly bd 600E | Poly bd 605E |
|---|---|---|
| Epoxide value (meq/g) | 2-2.5 | 3-4 |
| Epoxide equivalent weight (g/mol) | 400-500 | 260-330 |
| Oxirane oxygen (%) | 3.4 | 4.8-6.2 |
| Viscosity at 30° C. (Pa · s) | 7 | 22 |
| Hydroxyl value (meq/g) | 1.70 | 1.74 |
| Molecular weight (g/mol) | 1 300 | 1 300 |

It is understood that the electrode binder comprises a polymer blend comprising at least one first polymer and at least one second polymer. The first polymer is the polybutadiene-based polymer, and the second polymer is the polymer comprising norbornene-based monomer units derived from polymerization of the compound of Formula II or the polymer of Formula III, III(a), or III(b).

According to another example, the “first polymer: second polymer” ratio is in the range of from about 6:1 to about 2:3, upper and lower limits included. For example, the “first polymer: second polymer” ratio is in the range of from about 5.5:1 to about 2:3, or from about 5:1 to about 2:3, or from about 4.5:1 to about 2:3, or from about 4:1 to about 2:3, or from about 6:1 to about 1:1, or from about 5.5:1 to about 1:1, or from about 5:1 to about 1:1, or from about 4.5:1 to about 1:1, or from about 4:1 to about 1:1, upper and lower limits included. According to a variant of interest, the “first polymer: second polymer” ratio is in the range of from about 4:1 to about 1:1, upper and lower limits included.

The present technology also relates to an electrode comprising an electrode material as defined herein. According to an example, the electrode may be on a current collector (for example, an aluminum or a copper foil). Alternatively, the electrode may be a self-supported electrode.

The present technology also relates to an electrolyte comprising coated particles as defined herein, wherein the core of the coated particle comprises an ionically conductive inorganic material.

According to an example, the electrolyte may be selected for its compatibility with the various elements of the electrochemical cell. Any type of compatible electrolyte is contemplated. According to an example, the electrolyte is a liquid electrolyte comprising a salt in a solvent. According to an alternative, the electrolyte is a gel electrolyte comprising a salt in a solvent and optionally a solvating polymer. According to another alternative, the electrolyte is a solid polymer electrolyte comprising a salt in a solvating polymer. According to another alternative, the electrolyte comprises an inorganic solid electrolyte material, for example, the electrolyte may be a ceramic-type solid electrolyte. According to another alternative, the electrolyte is a polymer-ceramic hybrid solid electrolyte.

According to another example, the inorganic ionically conductive material is selected from inorganic ionically conductive materials, glasses, glass-ceramics, ceramics, nano-ceramics, and a combination of at least two thereof.

According to another example, the ionically conductive inorganic material comprises a ceramic, a glass, or a glass-ceramic in crystalline and/or amorphous form. For example, the ceramic, glass, or glass-ceramic particles may be based on fluoride, phosphide, sulfide, oxysulfide, oxide, or a combination thereof. According to another example, the ionically conductive inorganic material is selected from LISICON, thio-LISICON, argyrodite, garnet, NASICON, perovskites type compounds, oxides, sulfides, oxysulfides, phosphides, fluorides, in crystalline and/or amorphous form, and a combination of at least two thereof.

According to another example, the ionically conductive inorganic material is selected from inorganic compounds of formulae MLZO (for example, M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂, and M₍₇₋ₐ₎La₃Zr_{(2-b)}Nb_{b}O₁₂); MLTaO (for example, M₇La₃ Ta₂O₁₂, M₅La₃ Ta₂O₁₂, and M₆La₃Ta_{1.5}Y_{0.5}O₁₂); MLSnO (for example, M₇La₃Sn₂O₁₂); MAGP (for example, M₁₊ₐAlₐGe₂₋ₐ(PO₄)₃); MATP (for example, M₁₊ₐAlₐTi₂₋ₐ(PO₄)₃); MLTiO (for example, M₃ₐLa_{(2/3-a)}TiO₃); MZP (for example, MₐZr_{b}(PO₄)_{c}); MCZP (for example, MₐCa_{b}Zr_{c}(PO₄)d); MGPS (for example, MₐGe_{b}P_{c}S_{d} such as M₁₀GeP₂S₁₂); MGPSO (for example, MₐGe_{b}P_{c}S_{d}Oₑ); MSiPS (for example, MₐSi_{b}P_{c}S_{d} such as M₁₀SiP₂S₁₂); MSiPSO (for example, MₐSi_{b}P_{c}S_{d}Oₑ); MSnPS (for example, MₐSn_{b}P_{c}S_{d} such as M₁₀SnP₂S₁₂); MSnPSO (for example, MₐSn_{b}P_{c}S_{d}Oₑ); MPS (for example, MₐP_{b}S_{c} such as M₇P₃S₁₁); MPSO (for example, MₐP_{b}S_{c}O_{d}); MZPS (for example, MₐZn_{b}P_{c}S_{d}); MZPSO (for example, MₐZn_{b}P_{c}S_{d}Oₑ); xM₂S-yP₂S₅; xM₂S-yP₂S₅-zMX; xM₂S-yP₂S₅-zP₂O₅; xM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (for example, MₐP_{b}S_{c}X_{d} such as M₇P₃S₁₁X, M₇P₂S₈X, and M₆PS₅X); MPSOX (for example, MₐP_{b}S_{c}O_{d}Xₑ); MGPSX (for example, MₐGe_{b}P_{c}S_{d}Xₑ); MGPSOX (for example, MₐGe_{b}P_{c}S_{d}OₑX_{f}); MSiPSX (for example, MₐSi_{b}P_{c}S_{d}Xₑ); MSiPSOX (for example, MₐSi_{b}P_{c}S_{d}OₑX_{f}); MSnPSX (for example, MₐSn_{b}P_{c}S_{d}Xₑ); MSnPSOX (for example, MₐSn_{b}P_{c}S_{d}OₑX_{f}); MZPSX (for example, MₐZn_{b}P_{c}S_{d}Xₑ); MZPSOX (for example, MₐZn_{b}P_{c}S_{d}OₑX_{f}); M₃OX; M₂HOX; M₃PO₄; M₃PS₄; and MₐPO_{b}N_{c} (where a=2b+3c−5);

wherein:
M is an alkali metal ion, an alkaline earth metal ion, or a combination thereof, and wherein when M comprises an alkaline earth metal ion, then the number of M is adjusted to achieve electroneutrality;
X is selected from F, Cl, Br, I, or a combination of at least two thereof;
a, b, c, d, e, and f are numbers other than zero and are, independently in each formula, selected to achieve electroneutrality; and
v, w, x, y, and z are numbers other than zero and are, independently in each formula, selected to obtain a stable compound.

According to a variant of interest, the ionically conductive inorganic material is selected from argyrodite-type inorganic compounds of formula Li₆PS₅X, wherein X is Cl, Br, I, or a combination of at least two thereof. For example, the ionically conductive inorganic material is Li₆PS₅Cl.

According to another example, the salt, if present in the electrolyte, may be an ionic salt, such as a lithium salt. Non-limiting examples of lithium salts include lithium hexafluorophosphate (LiPF₆), lithium bis(trifluoromethanesulfonyl)imide (LiTFSl), lithium bis(fluorosulfonyl)imide (LiFSl), lithium 2-trifluoromethyl-4,5-dicyanoimidazolate (LiTDl), lithium 4,5-dicyano-1,2,3-triazolate (LiDCTA), lithium bis(pentafluoroethylsulfonyl)imide (LiBETl), lithium difluorophosphate (LiDFP), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiOTf), lithium fluoroalkylphosphate Li[PF₃(CF₂CF₃)_{3]} (LiFAP), lithium tetrakis(trifluoroacetoxy)borate Li[B(OCOCF₃)_{4]} (LiTFAB), lithium bis(1,2-benzenediolato(2-)-O,O′)borate Li[B(C₆O₂)_{2]} (LiBBB), lithium difluoro(oxalato)borate (LiBF₂(C₂O₄)) (LiFOB), a salt of formula LiBF₂O₄R^{x} (where R^{x}=C₂₋₄alkyl), and a combination of at least two thereof.

According to another example, the solvent, if present in the electrolyte, may be a non-aqueous solvent. Non-limiting examples of solvents include cyclic carbonates such as ethylene carbonate (EC), propylene carbonate (PC), butylene carbonate (BC), and vinylene carbonate (VC); acyclic carbonates such as dimethyl carbonate (DMC), diethyl carbonate (DEC), ethylmethyl carbonate (EMC), and dipropyl carbonate (DPC); lactones such as γ-butyrolactone (γ-BL) and γ-valerolactone (γ-VL); acyclic ethers such as 1,2-dimethoxyethane (DME), 1,2-diethoxyethane (DEE), ethoxymethoxyethane (EME), trimethoxymethane, and ethylmonoglyme; cyclic ethers such as tetrahydrofuran, 2-methyltetrahydrofuran, 1,3-dioxolane, and dioxolane derivatives; and other solvents such as dimethylsulfoxide, formamide, acetamide, dimethylformamide, acetonitrile, propylnitrile, nitromethane, phosphoric acid triester, sulfolane, methylsulfolane, propylene carbonate derivatives, and mixtures thereof.

According to another example, the electrolyte is a gel electrolyte or a gel polymer electrolyte. The gel polymer electrolyte may comprise, for example, a polymer precursor and a salt (for example, a salt as previously defined), a solvent (for example, a solvent as previously defined), and a polymerization and/or crosslinking initiator, if necessary. Examples of gel electrolytes include, without limitation, gel electrolytes such as those described in PCT patent applications published under numbers WO2009/111860 (Zaghib et al.) and WO2004/068610 (Zaghib et al.).

According to another example, a gel electrolyte or liquid electrolyte as defined above may also impregnate a separator such as a polymer separator. Examples of separators include, but are not limited to, polyethylene (PE), polypropylene (PP), cellulose, polytetrafluoroethylene (PTFE), polyvinylidene fluoride (PVDF), and polypropylene-polyethylene-polypropylene (PP/PE/PP) separators. For example, the separator is a commercial polymer separator of the Celgard™ type.

According to another example, the electrolyte is a solid polymer electrolyte. For example, the solid polymer electrolyte may be selected from any known solid polymer electrolyte and may be selected for its compatibility with the various components of an electrochemical cell. Solid polymer electrolytes generally comprise a salt as well as one or more solid polar polymer(s), optionally crosslinked. Polyether-type polymers, such as those based on polyethylene oxide (POE), may be used, but several other compatible polymers are also known for the preparation of solid polymer electrolytes and are also contemplated. The polymer may be crosslinked. Examples of such polymers include branched polymers, for example, star-shaped polymers or comb-shaped polymers such as those described in the PCT patent application published under number WO2003/063287 (Zaghib et al.).

According to another example, the solid polymer electrolyte may include a block copolymer composed of at least one lithium-ion solvating segment and optionally at least one crosslinkable segment. Preferably, the lithium-ion solvation segment is selected from homo- or copolymers having repeating units of Formula VIII:

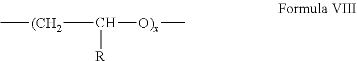

wherein,
R is selected from a hydrogen atom, and a C₁-C₁₀alkyl group or a −(CH₂—O—R^{a}R^{b}) group;
R^{a} is (CH₂—CH₂—O)_{y};
R^{b} is selected from a hydrogen atom and a C₁-C₁₀alkyl group;
x is an integer selected from the range of 10 to 200 000; and
y is an integer selected from the range of 0 to 10.

According to another example, the crosslinkable segment of the copolymer is a polymer segment comprising at least one functional group that is multi-dimensionally crosslinkable by irradiation or thermal treatment.

When the electrolyte is a liquid electrolyte, a gel electrolyte, or a solid polymer electrolyte, the coated particles as defined herein may be present as an additive in the electrolyte.

When the electrolyte is a polymer-ceramic hybrid solid electrolyte or a ceramic-type solid electrolyte, the coated particles as defined herein may be present as an inorganic solid electrolyte (ceramic) material.

According to another example, the electrolyte may also optionally include additional components such as ionic conductive materials, inorganic particles, glass or ceramic particles as defined above, and other additives of the same type. According to another example, the additional component may be a dicarbonyl compound such as those described in the PCT patent application published under number WO2018/116529 (Asakawa et al.). For example, the additional component may be poly(ethylene-alt-maleic anhydride) (PEMA). The additional component may be selected for its compatibility with the various elements of an electrochemical cell. According to an example, the additional component may be substantially dispersed in the electrolyte. Alternatively, the additional component may be present in a separate layer.

The present technology also relates to a coating material for a current collector comprising coated particles as defined herein, wherein the core of the coated particle comprises an electronically conductive material. For example, the coated particles may be coated conductive carbon particles which may be applied onto a metallic current collector foil (for example, an aluminum or copper foil). A current collector comprising the coating material applied on a metal foil is also contemplated.

The present technology also relates to an electrochemical cell comprising a negative electrode, a positive electrode, and an electrolyte, wherein at least one of the positive electrode or the negative electrode is as defined herein or comprises an electrode material as defined herein.

According to a variant of interest, the negative electrode is as defined herein or comprises an electrode material as defined herein. For example, the electrochemically negative electrode material may be selected for its electrochemical compatibility with the various elements of the electrochemical cell as defined herein. For example, the electrochemically active material of the negative electrode material may have a substantially lower oxidation-reduction potential than that of the electrochemically active material of the positive electrode.

According to another variant of interest, the positive electrode is as defined herein or comprises an electrode material as defined herein, and the negative electrode includes an electrochemically active material selected from all known compatible electrochemically active materials. For example, the electrochemically active material of the negative electrode may be selected for its electrochemical compatibility with the various elements of the electrochemical cell as defined herein. Non-limiting examples of electrochemically active materials of the negative electrode include alkali metals, alkaline earth metals, alloys comprising at least one alkali or alkaline earth metal, non-alkali and non-alkaline-earth metals (for example, indium (In), germanium (Ge), and bismuth (Bi)), and intermetallic alloys or compounds (for example, SnSb, TiSnSb, Cu₂Sb, AlSb, FeSb₂, FeSn₂, and CoSn₂). For example, the electrochemically active material of the negative electrode may be in the form of a film having a thickness in the range of from about 5 μm to about 500 μm, and preferably in the range of from about 10 μm to about 100 μm, upper and lower limits included. According to a variant of interest, the electrochemically active material of the negative electrode may comprise a film of metallic lithium or an alloy including or based on metallic lithium.

According to another example, the positive electrode may be pre-lithiated and the negative electrode may be initially (i.e., before cycling the electrochemical cell) substantially or completely free of lithium. The negative electrode may be lithiated in situ during the cycling of said electrochemical cell, particularly during the first charge. According to an example, metallic lithium may be deposited in situ on the current collector (for example, a copper current collector) during the cycling of the electrochemical cell, particularly during the first charge. According to another example, an alloy including metallic lithium may be generated on the surface of a current collector (for example, an aluminum current collector) during the cycling of the electrochemical cell, particularly during the first charge. It is understood that the negative electrode may be generated in situ during the cycling of the electrochemical cell, particularly during the first charge.

According to another variant of interest, the positive electrode and the negative electrode are both as defined herein, or both comprise an electrode material as defined herein.

The present technology also relates to an electrochemical cell comprising a negative electrode, a positive electrode, and an electrolyte, wherein the electrolyte is as defined herein.

The present technology also relates to an electrochemical cell comprising a negative electrode, a positive electrode, and an electrolyte, wherein at least one of the positive electrode and the negative electrode is on a current collector as defined herein or comprising a coating material as defined herein.

The present technology also relates to a battery comprising at least one electrochemical cell as defined herein. For example, the battery may be a primary battery (cell) or a secondary battery (accumulator). According to an example, the battery is selected from the group consisting of a lithium battery, a lithium-ion battery, a sodium battery, a sodium-ion battery, a magnesium battery, a magnesium-ion battery, a potassium battery, and a potassium-ion battery. According to a variant of interest, the battery is an all-solid-state battery.

According to another example, the coating material can allow a substantial reduction in the number and size of particle agglomerates in the dispersion. For example, the coating material allows a substantial reduction in the number and size of agglomerates of particles of electronically conductive material or ceramic-type electrolyte material. Without wishing to be bound by theory, for example, repulsive interactions linked to the coating material may allow better dispersion of the positive electrode components in the dispersion, and this, by modifying or not the other components allowing this type of interaction. For example, repulsive interactions may be π-π and/or polar type interactions.

According to another example, the coating material may also substantially limit parasitic reactions with the other components of the electrochemical cell, and thus improve the cycling and aging stability of the electrochemical cell.

According to another example, the coating material may also substantially limit the resistance to charge transfer and may allow to substantially improve the ionic and/or electronic conductivity thanks to the double or triple bonds present in the coating material. Without wishing to be bound by theory, the π-orbitals of the coating material as defined herein may allow orbital delocalization and thus orbital interactions with ions and/or electrons.

According to another example, the coating material may also substantially improve the safety of the electrochemical cell, for example, by reducing gas generation. For example, when applied to a sulfide-based ceramic electrolyte material particle, the coating may substantially reduce the amount of hydrogen sulfide (H₂S) generated by exposure of the coated material to moisture or ambient air.

According to an example, the coating material may also include organic compounds or molecules allowing to trap gas molecules (for example, H₂S) and/or allowing to form a barrier in order to reduce the introduction of humidity to reduce the formation of H₂S.

### EXAMPLES

The following examples are for illustrative purposes and should not be construed as further limiting the scope of the invention as contemplated. These examples will be better understood by referring to the accompanying figures.

### Example 1—Preparation of Argyrodite-Type Ceramic Particles of Formula Li₆PS₅Cl

The coating of the Li₆PS₅Cl particles was carried out by a wet particle grinding process.

The coating of the Li₆PS₅Cl particles was carried out using a PULVERISETTE™ 7 planetary micro mill. 4 g of Li₆PS₅Cl particles were placed in an 80 ml zirconium oxide (or zirconia) grinding jar. A mixture comprising 20 ml anhydrous decane and 7 ml squalene (75:25 by volume) and grinding beads having a diameter of 2 mm were added to the jar. The Li₆PS₅Cl particles and the mixture of decane and squalene were combined by grinding at a speed of about 300 rpm for about 7.5 hours to produce Li₆PS₅Cl particles coated with the mixture of decane and squalene. The resulting particles were then dried under vacuum at a temperature of about 80° C.

The same coating process was carried out (i) with decane, (ii) with a mixture of decane and squalene (90:10 by volume), (iii) with a mixture of decane and farnesene (85:15 by volume), and (iV) with a mixture of decane, farnesene, and squalene (85:7.5:7.5 by volume).

### Example 2—Preparation of the modified electronically conductive material

a) Coating of electronically conductive particles with a mixture of decane and squalene (75:25 by volume)

The coating process described in Example 1 is used to coat the electronically conductive material. More specifically, the wet particle milling process is used to coat carbon black with a coating material comprising a mixture of decane and squalene (75:25 by volume).

b) Grafting of particles of electronically conductive material with at least one aryl group of Formula I

The following process for the production of electronically conductive material was applied to carbon black.

5 g of carbon black were dispersed in 200 ml of a 0.5 M sulfuric acid (H₂SO₄) aqueous solution, then 0.01 equivalents of aniline p-substituted with a hydrophilic substituent (—SO₃H which was then lithiated in order to exchange the hydrogen with lithium) was added to the mixture (i.e., 0.01 equivalent of aniline relative to carbon black). The mixture was then stirred vigorously until the amine was completely dissolved.

After addition of 0.03 equivalents of sodium nitrite (NaNO₂) relative to carbon black (for example, 3 equivalents of NaNO₂ relative to aniline), the corresponding aryl diazonium ion was generated in situ and reacted with carbon black. The mixture thus obtained was left to react overnight at room temperature.

Once the reaction was complete, the mixture was filtered under vacuum using a vacuum filtration assembly (Büchner-type) and a nylon filter with a pore size of 0.22 μm. The modified carbon black powder thus obtained was then washed successively with deionized water until a neutral pH was reached, then with acetone. Finally, the modified carbon black powder was then dried under vacuum at 100° C. for at least one day before use.

### Example 3—Characterization of the Coated Particles

a) Scanning electron microscopy (SEM)

The Li₆PS₅Cl particles coated with the mixture of decane and squalene (75:25 by volume) prepared in Example 1 were characterized by SEM imaging.

FIG. 1 shows in (A) an image obtained by SEM of Li₆PS₅Cl particles before the grinding and coating step, and in (B) an image obtained by SEM of Li₆PS₅Cl particles coated with the mixture of decane and squalene (75:25 by volume) prepared in Example 1. The scale bars represent 20 μm.

FIG. 1(B) confirms the reduction in size of the Li₆PS₅Cl particles and the presence of the coating on them and does not show any agglomeration of said particles following the coating.

b) Thermogravimetric analysis (TGA)

The Li₆PS₅Cl particles coated with squalene prepared in Example 1 were characterized by TGA imaging.

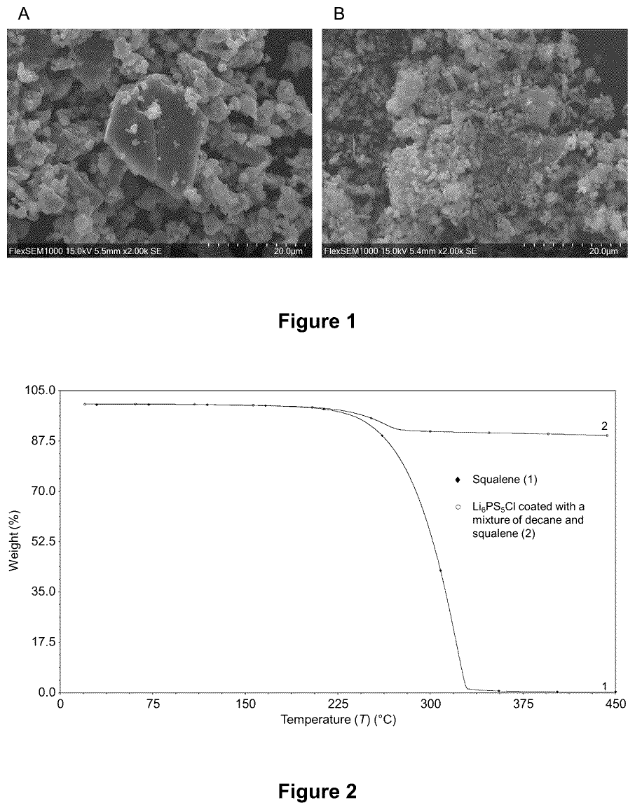

The thermogravimetric curves of squalene (♦; curve 1) and Li₆PS₅Cl particles coated with squalene prepared in Example 1 (○; curve 2) are presented in FIG. 2. The thermogravimetric analyses were carried out at a temperature heating rate of 10° C./min. FIG. 2 shows that squalene remains stable up to about 254° C., the temperature at which the onset of thermal degradation can be observed. FIG. 2 also shows a mass variation for the sample comprising the Li₆PS₅Cl particles particles coated with squalene at a similar temperature. Indeed, it is possible to observe a loss of mass starting at a temperature of about 233° C., which corresponds to the thermal evaporation signature of squalene adsorbed on the surface of the particles. A slight difference in temperature can be observed due to the fact that, unlike pure squalene, which is free, the squalene which constitutes the coating of the particles is adsorbed in a thin layer. FIG. 2 confirms the presence of the squalene coating on the Li₆PS₅Cl particles.

### c) Nuclear Magnetic Resonance (NMR)

Proton and carbon nuclear magnetic resonance spectra (¹H and ¹³C NMR) were obtained using the MAS (magic angle spinning) technique using a Bruker Avance™ NEO 500 MHZ spectrometer equipped with a 4 mm triple resonance probe with a maximum magic angle spinning speed of 15 KHz.

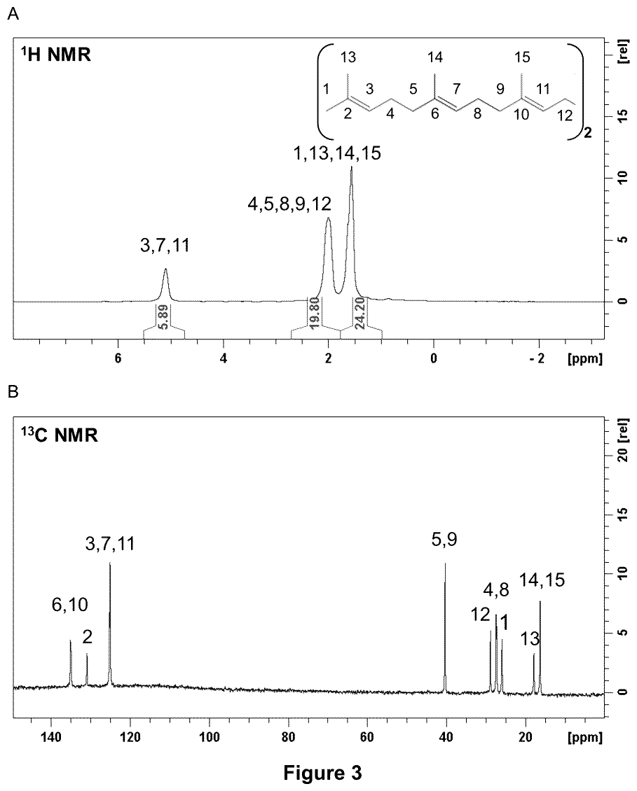

FIG. 3 shows in (A) a ¹H NMR spectrum, and in (B) a ¹³C NMR spectrum both obtained for the Li₆PS₅Cl particles coated with the mixture of decane and squalene (75:25 by volume) prepared in Example 1 and dried at a temperature of about 80° C.under vacuum for about 5 hours.

The ¹H NMR signals as well as the value of the integral of these signals (in red) of the ¹H and ¹³C NMR spectra presented in FIG. 3(A) confirm the presence of squalene, even after the drying step at a temperature of about 80° C.

The assignment of the ¹³C NMR signals shown in FIG. 3(B) was carried out based on the data reported by Nam et al. (Nam, A. M., et al. “Quantification of squalene in olive oil using ¹³C nuclear magnetic resonance spectroscopy”, Magnetochemistry 3.4 (2017): 34). These signals confirm the presence of squalene on the surface of the particles without modification of its structure.

FIG. 4 presents a ¹H NMR spectrum obtained for the Li₆PS₅Cl particles coated with the mixture of decane and farnesene (85:15 by volume) prepared in Example 1 and dried at a temperature of about 80° C. under vacuum for about 5 hours. FIG. 4 also presents a ¹H NMR spectrum obtained for pure farnesene.

By comparing the spectrum obtained for the Li₆PS₅Cl particles coated with a mixture of decane and farnesene (85:15 by volume) with the spectrum obtained for pure farnesene, it is possible to confirm the presence of farnesene on the surface of the particles, and this, without modification of its structure.

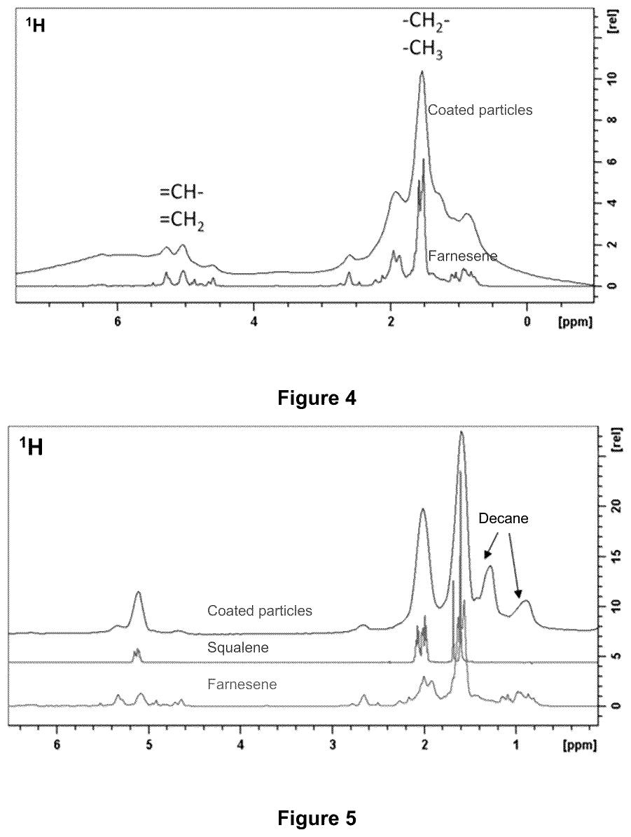

FIG. 5 presents a ¹H NMR spectrum obtained for the Li₆PS₅Cl particles coated with the mixture of decane, squalene, and farnesene (85:7.5:7.5 by volume) prepared in Example 1 and dried at a temperature of about 80° C. under vacuum for about 5 hours. FIG. 5 also presents ¹H NMR spectra obtained for pure farnesene and squalene.

By comparing the spectrum obtained for the Li₆PS₅Cl particles coated with the mixture of decane, squalene, and farnesene with the spectra obtained for pure farnesene and squalene, it is possible to confirm the presence of squalene and farnesene on the surface of the particles, without modification of their structure.

Thus, it is possible to coat different unsaturated aliphatic hydrocarbons on the surface of particles, and this, without modification of their structure.

### Example 4—Preparation and Characterization of the Positive Electrode Films

a) Preparation of positive electrode films

1.55 g of LiNi_{0.6}Mn_{0.2}Co_{0.2}O₂ (NMC 622) particles coated with a LiNbO₃-type oxide from a commercial source having an average diameter of about 4 μm were mixed with 0.40 g of Li₆PS₅Cl particles prepared in Example 1 having an average diameter of about 200 nm and 0.5 g of carbon black or modified carbon black in order to form a mixture of dry powders. The dry powders were mixed for about 10 minutes using a vortex mixer. A polymer solution was prepared separately by dissolving 0.04 g of polybutadiene and 0.01 g of polynorbornene in 0.94 g of tetrahydrofuran.

The polymer solution was added to the dry powder mixture. The mixture thus obtained was mixed for about 5 minutes using a planetary centrifugal mixer (Thinky Mixer). An additional solvent, methoxybenzene, was added to the mixture to achieve an optimal coating viscosity of about 10 000 cP. The suspension thus obtained was coated onto an aluminum foil using the doctor blade coating method to obtain a positive electrode film applied on a current collector. The positive electrode film was then dried under vacuum at a temperature of about 120° C. for about 5 hours.

A positive electrode film with uncoated Li₆PS₅Cl particles as an additive was also obtained for comparison by the process of the present example.

The aluminum foil could also be an unmodified carbon-coated aluminum foil, or a carbon-coated aluminum foil coated with the coating material as defined herein.

The composition of the positive electrode films is presented in Table 2.

TABLE 2
Composition of the positive electrode films

| | Composition of the positive electrode films | | | | |
|---|---|---|---|---|---|
| | | | | Electronically | |
| | Electrochemically | Li₆PS₅Cl | | conductive | |
| Film | active material | Additive | Coating* | material | Binder** |
| Film 1 | LiNbO₃-NMC622 | Li₆PS₅Cl | — | Unmodified | PB-PNB |
| Film 2 | LiNbO₃-NMC622 | Li₆PS₅Cl | Decane:SQ | Unmodified | PB-PNB |
| | | | (75:25 by volume) | | |
| Film 3 | LiNbO₃-NMC622 | Li₆PS₅Cl | Decane | Prepared in | PB-PNB |
| | | | | Example 2(b) | |
| Film 4 | LiNbO₃-NMC622 | Li₆PS₅Cl | Decane:SQ | Prepared in | PB-PNB |
| | | | (90:10 by volume) | Example 2(b) | |
| Film 5 | LiNbO₃-NMC622 | Li₆PS₅Cl | Decane:SQ | Prepared in | PB-PNB |
| | | | (75:25 by volume) | Example 2(b) | |
| Film 6 | LiNbO₃-NMC622 | Li₆PS₅Cl | — | Prepared in | PB-PNB |
| | | | | Example 2(b) | |
| Film 7 | LiNbO₃-NMC622 | Li₆PS₅Cl | Decane:FN | Prepared in | PB-PNB |
| | | | (85:15 by volume) | Example 2(b) | |
| Film 8 | LiNbO₃-NMC622 | Li₆PS₅Cl | Decane:SQ:FN | Prepared in | PB-PNB |
| | | | (85:7.5:7.5 by volume) | Example 2(b) | |

*SQ: squalene; FN: farnesene.
**PB: polybutadiene; PNB: polynorbornene.

b) Characterization of the positive electrode films prepared in Example 4(a)

Morphological studies of the different positive electrode films were carried out using a scanning electron microscope (SEM) equipped with an energy dispersive X-ray spectroscopy (EDS) detector.

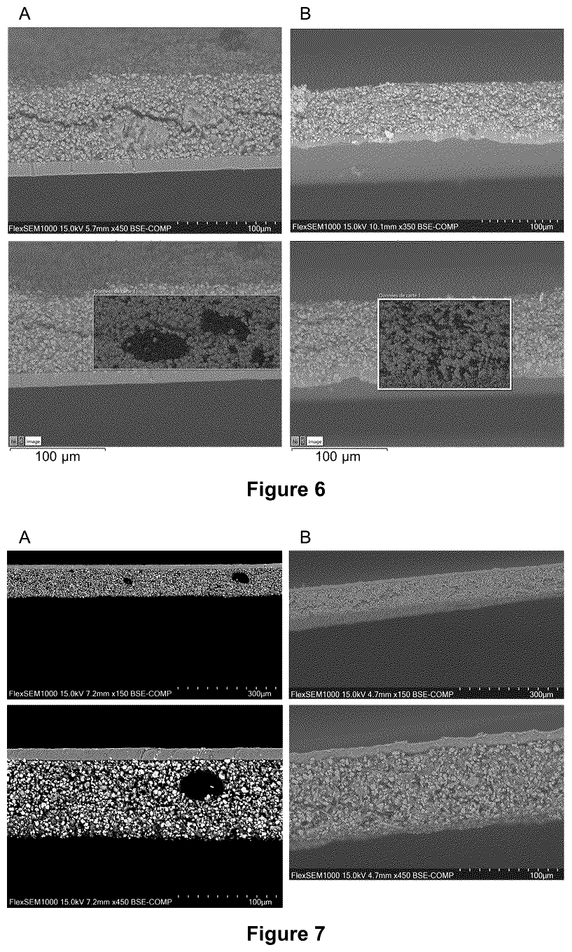

FIG. 6 shows in (A) and (B) images obtained by SEM and elemental microanalyses by EDS allowing the analysis of the distribution of elements (Ni and S) by mapping obtained respectively for Films 1 and 2 prepared in Example 4(a). The scale bars represent 100 μm.

It is possible to observe in FIG. 6(A) the presence of sulfide agglomerates on the section of the positive reference electrode film comprising uncoated Li₆PS₅Cl particles (Film 1). Comparatively, FIG. 6(B) confirms the absence of these agglomerates when analyzing the section of Film 2 including Li₆PS₅Cl particles coated with the decane: squalene mixture (75:25 by volume).

Thus, the coating of Li₆PS₅Cl particles with unsaturated aliphatic hydrocarbons comprising at least one double or triple bond allows their good dispersion and the absence of agglomerates.

FIG. 7 shows in (A) an image obtained by SEM for Film 3 and an enlargement of this image, and in (B) an image obtained by SEM for Film 4 and an enlargement of this image. The scale bars of the SEM images and their enlargements represent 300 μm and 100 μm respectively.

It is possible to observe in FIG. 7(A) the presence of carbon agglomerates on the section of Film 3 composed of a positive reference electrode film comprising Li₆PS₅Cl particles coated with decane. The presence of these carbon agglomerates could cause a reduction in electrochemical performance, particularly from the point of view of electronic percolation, and therefore, stability and cycling performance. Comparatively, FIG. 7(B) confirms the absence of these agglomerates on the surface of Film 4 including Li₆PS₅Cl particles coated with the mixture of decane: squalene (75:25 by volume).

Thus, the coating of ionically conductive inorganic particles with unsaturated aliphatic hydrocarbons comprising at least one double or triple bond coupled with the modification of the surface of the electronically conductive material with polar groups allows the repulsion of these two types of particles and thus ensures good dispersion and homogeneity of the composition in the thickness and on the surface of the films.

### Example 5—Electrochemical Properties

The electrochemical properties of the positive electrode films prepared in Example 4(a) were studied.

a) Electrochemical cell configurations

The electrochemical cells were assembled according to the following procedure.

Pellets of 10 mm in diameter were taken from the positive electrode films prepared in Example 4(a). Sulfide ceramic-type inorganic solid electrolytes were prepared by placing 80 mg of Li₆PS₅Cl sulfide ceramic on the surface of the positive electrode film pellets. The positive electrode film pellets including the inorganic solid electrolyte layer were then compressed under a pressure of 2.8 tons using a press. They were then assembled, in a glove box, in CR²⁰³² type button cell cases facing metallic lithium electrodes 10 mm in diameter on aluminum and copper current collectors. The electrochemical cells were assembled according to the configurations presented in Table 3.

TABLE 3
Electrochemical cell configurations

| Cell | Positive electrode film | Negative electrode |
|---|---|---|
| Cell 1 | Film 2 | Metallic lithium |
| Cell 2 | Film 5 | Metallic lithium |
| Cell 3 | Film 6 | Metallic lithium |
| Cell 4 | Film 3 | Metallic lithium |
| Cell 5 | Film 4 | Metallic lithium |
| Cell 6 | Film 7 | Metallic lithium |
| Cell 7 | Film 8 | Metallic lithium |

### b) Behavior of the Positive Electrode Films

This example illustrates the electrochemical behavior of the electrochemical cells described in Example 5(a).

The electrochemical cells assembled in Example 5(a) were cycled between 4.3 V and 2.5 V vs Li/Li⁺ at a temperature of 50° C. The formation cycle was carried out at a constant charge and discharge current of C/15. Then four cycles were performed at a constant charge and discharge current of C/10 followed by four cycles at a constant charge and discharge current of C/5. Finally, aging experiments were carried out at a constant charge and discharge current of C/3.

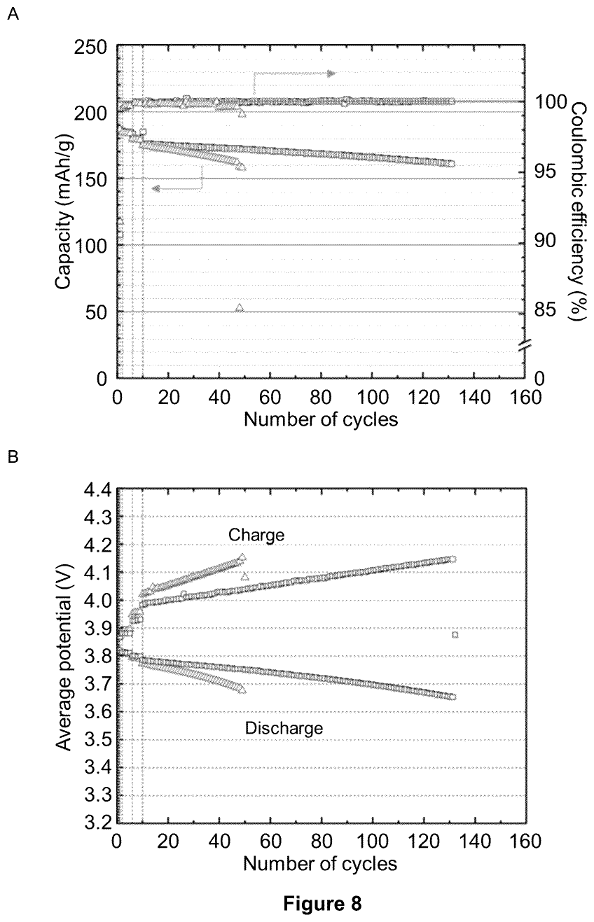

FIG. 8 shows in (A) a graph of the discharge capacity (mAh/g) and the coulombic efficiency (%) as a function of the number of cycles, and in (B) a graph of average charge and discharge potential (V) as a function of the number of cycles for Cell 1 (▴) and Cell 2 (▪), as described in Example 3(a).

It is possible to observe that the cycling performances are substantially improved by coating the electronically conductive material with the coating materials as defined herein. Indeed, as it can be observed, Cell 2 exhibits improved capacity retention during long cycling experiments in comparison with Cell 1. Thus the coating of the ionically conductive inorganic particles with unsaturated aliphatic hydrocarbons comprising at least one double or triple bond coupled with the modification of the surface of the electronically conductive material with polar groups allows the repulsion of these two types of particles and ensures improved ionic and electronic percolation, which results in improved capacity retention and coulombic efficiency, as well as in a lower average potential thanks to the reduction in charge transfer resistance.

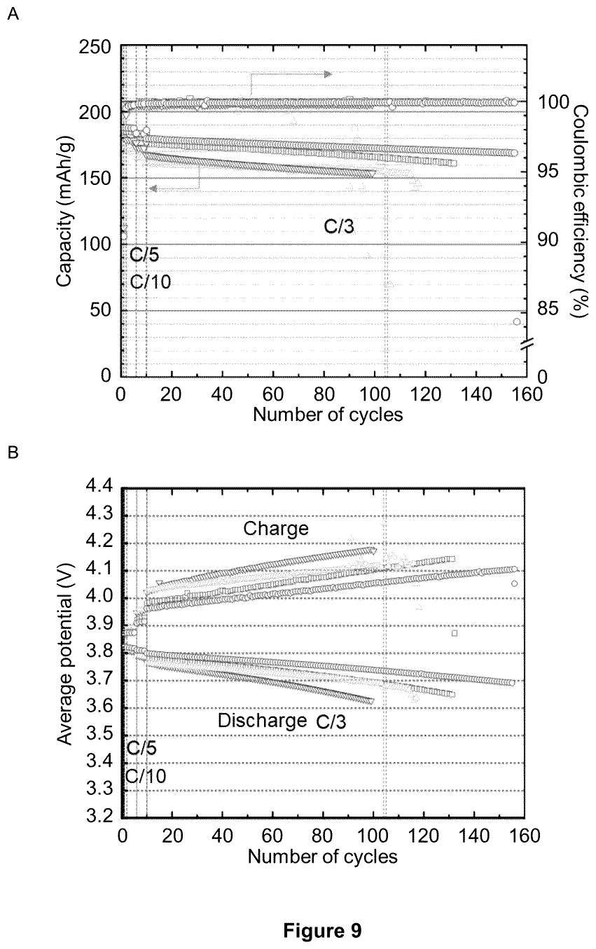

FIG. 9 shows in (A) a graph of the discharge capacity (mAh/g) and the coulombic efficiency (%) as a function of the number of cycles, and in (B) a graph of the average charge and discharge potential (V) as a function of the number of cycles for Cell 2 (▪), Cell 3 (▴), Cell 4 (▾), and Cell 5 (●), as described in Example 3(a).

As it can be observed, among all the cells tested, an improved capacity retention is obtained for Cells 2 and 5 comprising Li₆PS₅Cl particles coated with a mixture of decane and squalene.

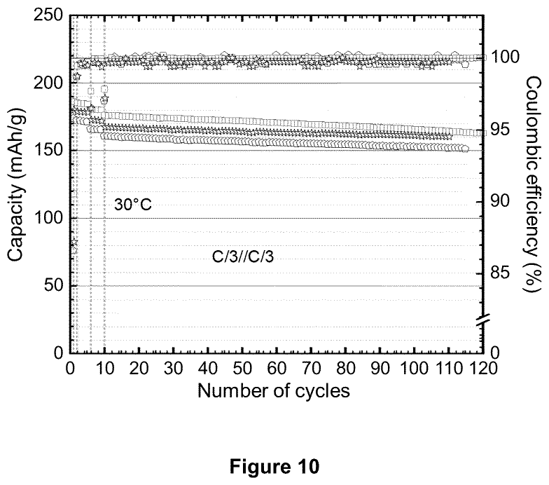

FIG. 10 shows a graph of the discharge capacity (mAh/g) and the coulombic efficiency (%) as a function of the number of cycles for Cell 2 (▪), Cell 6 ( [symbol] ), and Cell 7 (★), as described in Example 3(a). As it can be observed, Cell 7 comprising Li₆PS₅Cl particles coated with a mixture of decane, squalene, and farnesene exhibits improved cycling ageing. This demonstrates the feasibility and benefits of coating the surface of particles with a mixture of several unsaturated aliphatic hydrocarbons. It is also possible to vary the ratios of these unsaturated aliphatic hydrocarbons in the mixture.

### Example 6—Characterization the Properties of the Coatings

a) Characterization of the properties of the coatings after cycling by proton nuclear magnetic resonance (¹H NMR)

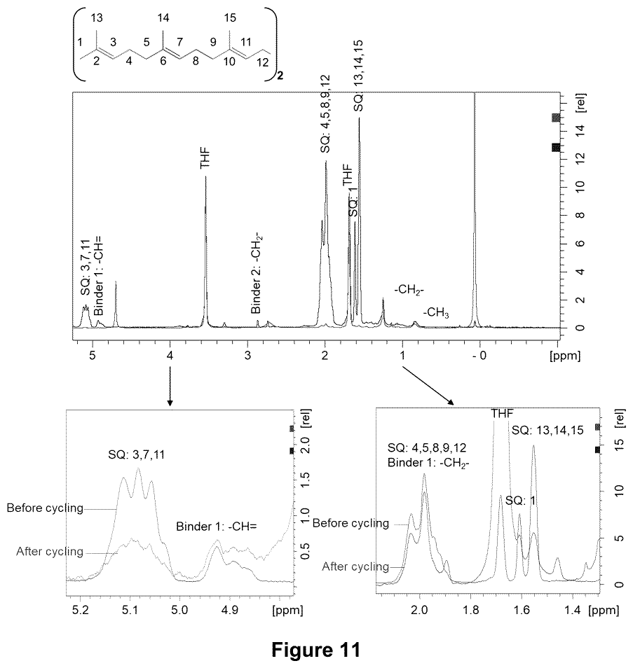

FIG. 11 shows proton nuclear magnetic resonance (¹H NMR) analysis results for liquid samples obtained from Film 4 extraction with tetrahydrofuran before cycling (blue) and after cycling (red).

The ¹H NMR spectra were obtained using a Bruker Avance™ NEO NanoBay 300 MHz spectrometer equipped with a 5 mm broadband double-resonance probe. The solvent used was deuterated tetrahydrofuran (THF-d8).

The two enlargements presented in FIG. 11 confirm the presence of squalene, before and after cycling, without modification of the squalene signal, even after 160 cycles. Therefore, particles coated with the coating material as defined herein do not degrade during aging, thus allowing the stability of the performance during aging as demonstrated in FIG. 9.

b) Hydrogen sulfide (H₂S) generation

The safety test was carried out to evaluate the impact of coating Li₆PS₅Cl particles on hydrogen sulfide (H₂S) generation. About 80 mg of Li₆PS₅Cl particle powder coated with decane (dashed line), coated with a decane: squalene mixture (85:15 by volume) (dash-dot-dot line), and coated with a decane: squalene mixture (75:25 by volume) (solid line) were each placed separately in a previously dried cell.

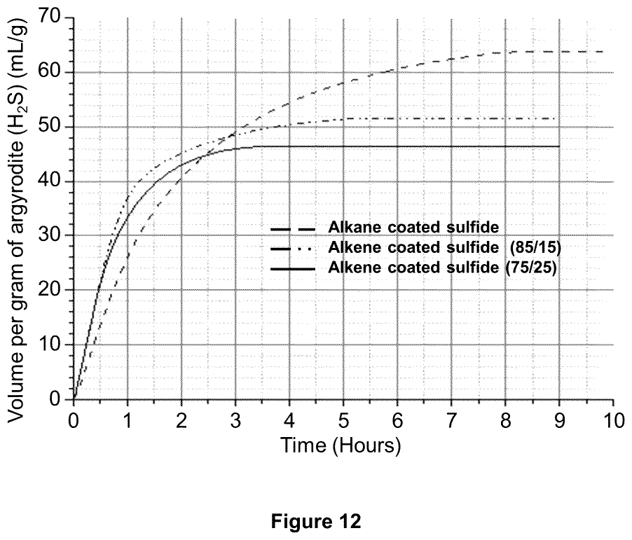

A quantity of ambient air at a controlled temperature of about 20° C. and controlled humidity was introduced into the cell. The amount of H₂S gas generated was measured with a portable detector. The results of these analyses are presented in FIG. 12. FIG. 12 shows a graph of the volume of H₂S gas generated per gram of powder (mL/g) as a function of time (hours). The sulfide coating could therefore allow to significantly reduce the amount of H₂S generated, and thus improve the safety of electrochemical systems.

Several modifications could be made to any of the above-described embodiments without departing from the scope of the present invention as contemplated. The references, patents or scientific literature documents referred to in the present application are incorporated herein by reference in their entirety for all purposes.

What is claimed is:

1. A coating material comprising at least one branched or linear unsaturated aliphatic hydrocarbon having from 10 to 50 carbon atoms and having at least one carbon-carbon double or triple bond for use in an electrochemical cell.

2. The coating material of claim 1, wherein the boiling temperature of the unsaturated aliphatic hydrocarbon is above 150° C. or the boiling temperature of the unsaturated aliphatic hydrocarbon is in the range of from about 150° C. to about 675° C. or from about 155° C. to about 670° C. , or from about 160° C. to about 665° C. or from about 165° C. to about 660° C. or from about 170° C. to about 655° C. upper and lower limits included.

3. (canceled)

4. The coating material of claim 1, wherein the unsaturated aliphatic hydrocarbon is selected from the group consisting of decene, dodecene, undecene, tridecene, tetradecene, pentadecene, hexadecene, heptadecene, octadecene, 1,9-decadiene, docosene, hexacosene, eicosene, tetracosene, squalene, farnesene, β-carotene, pinenes, dicyclopentadiene, camphene, α-phellandrene, β-phellandrene, terpinenes, β-myrcene, limonene, 2-carene, sabinene, α-cedrene, copaene, β-cedrene, decyne, dodecyne, octadecyne, hexadecyne, tridecyne, tetradecyne, docosyne, and a combination of at least two thereof, preferably the unsaturated aliphatic hydrocarbon is selected from the group consisting of decene, dodecene, undecene, tridecene, tetradecene, pentadecene, hexadecene, haptadecene, octadecene, 1,9-decadiene, docosene, hexacosene, eicosene, tetracosene, squalene, farnesene, β-carotene, and a combination of at least two thereof, more preferably the unsaturated aliphatic hydrocarbon is selected from the group consisting of decene, undecene, octadecene, squalene, farnesene, β-carotene and a combination of at least two thereof, and even more preferably the unsaturated aliphatic hydrocarbon comprises squalene, farnesene, or squalene ad farnesene.

5-9. (canceled)

10. The coating material of claim 1, which is a mixture comprising the unsaturated aliphatic hydrocarbon and an additional component preferably being an alkane or a mixture comprising an alkane and a polar solvent, wherein:
the alkane preferably comprises from 19 to 50 carbon atoms, and preferably the alkane is decane; and
the polar solvent is selected from tetrahydrofuran, acetonitrile, N,N-dimethlyformamide, and a miscible combination of at least two thereof, and preferably the polar solvent is tetrahydrofuran.

11-15. (canceled)

16. Coated particles for use in an electrochemical cell, said coated particle comprising:
a core comprising an electrochemically active material, an electronically conductive material, or an ionically conductive inorganic material; and
a coating material as defined in claim 1, the coating material being disposed on the surface of the core, wherein the coating material forms a homogeneous coating layer on the surface of the core or is heterogeneously dispersed on the surface of the core and forms a coating layer on at least part of the surface of the core.

17-19. (canceled)

20. The coated particles of claim 16, which are used in an electrode material, an electrolyte, or a current collector.

21-22. (canceled)

23. A process for manufacturing coated particles as defined in claim 16, the process comprising at least one step of coating at least a part of the surface of the core with the coating material preferably carried out by a dry coating process or by a wet coating process, wherein the wet coating process is preferably a mechanical coating process, and more preferably the mechanical coating process is a mechanosynthesis or mechanofusion process.

24-27. (canceled)

28. The process of claim 23, further comprising a step of grinding the electrochemically active material, the electronically conductive material, or the ionically conductive inorganic material of the core of the coated particle, wherein the coating and grinding steps are carried out simultaneously, sequentially, or partially overlapping in time, and preferably the coating and grinding steps are carried out simultaneously.

29-30. (canceled)

31. An electrode material comprising:
coated particles as defined in claim 16, wherein the core of the coated particle comprises an electrochemically active material; and/or
an electrochemically active material and coated particles as defined in claim 16;
wherein the core of the coated particle preferably comprises the electrochemically active material.

32. (canceled)

33. The electrode material of claim 31, wherein:
the electrochemically active material is selected from a metal oxide, a metal sulfide, a metal oxysulfide, a metal phosphate, a metal fluorophosphate, a metal oxyfluorophosphate, a metal sulfate, a metal halide, a metal fluoride, sulfur, selenium, and a combination of at least two thereof, the metal of be electrochemically active material preferably being selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and a combination of at least two thereof, and preferably the metal of the electrochemically active material further comprises an alkali or alkaline earth metal selected from lithium (Li), sodium (Na), potassium (K), and magnesium (Mg):
the electrochemically active material is a lithium metal oxide, and preferably the lithium metal oxide is a mixed oxide of lithium, nickel, manganese, and cobalt (NMC);
the electrochemically active material is a lithium metal oxide, and preferably the lithium metal oxide is a mixed oxide of lithium, nickel, maganese, and cobalt (NMC);
the electrochemically active material is a lithiated metal phosphate, and preferably the lithiated metal phosphate is lithiated iron phosphate; or
the electrochemically active material is selected from a non-alkali or non-alkaline-earth metal, an intermetallic compound, a metal oxide, a metal nitride, a metal phosphide, a metal phosphate, a metal halide, an metal oxide, a metal nitride, a metal phosphide, a metal silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and a combination of at least two thereof.

34-41. (canceled)

42. The electrode material of claim 31, wherein the electrochemically active material further comprises a element, an embedding material, or a combination thereof, wherein the embedding material preferably forms an embedding layer on the surface of said electrochemically active material and the coating material is disposed on the surface of the embedding layer, and preferably wherein:
wherein the embedding material is selected from LiₛSiO₃, LiTaO₃, LiAlO₂, Li₂O—ZrO₂, LiNbO₃, other similar embedding materials, and a combination of at least two thereof, and preferably the embedding material is LiNbO₃; or
The embedding material is an electronically conductive material, and preferably the electronically conductive material is carbon.

43-47. (canceled)

48. The electrode material of claim 31, further comprising at least one electronically conductive material, and preferably wherein:
the core of the coated particle comprises the electronically conductive material;
the electronically conductive material is selected from the group consisting of carbon black, acetylene black, graphite, graphene, carbon fibers, carbon nanofibers, carbon nanotubes, and a combination of at least two thereof, and preferably the electronically conductive material is carbon black; or
the surface of said electronically conductive material is grafted with at least one aryl group of Formula I: 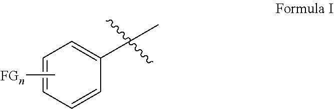
wherein,
FG is a hydrophilic functional group preferably being a carboxylic acid or sulfonic acid function group; and
n is an integer in the range of from 1 to 5, preferably n is in the range of from 1 to 3, preferably n is 1 or 2, of more preferably n is 1:
the aryl group of Formula 1 preferably being p-benzoic acid or p-benzenesulfonic acid.

49-54. (canceled)

55. The electrode material of claim 31, further comprising at least one additive, and preferably wherein:
(i) the core of the coated particle comprises the additive,
(ii) the additive is selected from inorganic ionic conductive materials, inorganic materials, glasses, glass-ceramics, ceramics, nano-ceramics, salts, and a combination of at least two thereof;
(iii) the additive comprises ceramic, glass, or glass-ceramic particles based on fluoride phosphide, sulfide, oxysulfide, or oxide,
(iv) the additive is selected from LISICON, thio-LISICON, argyrodite, garnet, NASICON, perovskite type compounds, oxides, sulfides, oxysulfides, phosphides, fluorides, in crystalline and/or amorphous form, and a combination of at least two thereof;
(v) the additive is selected from inorganic compounds of the formulae:
MLZO (for example, M₇La₃Zr₂O₁₂, M₍₇₋ₐ₎La₃Zr₂AlₐO₁₂, M₍₇₋ₐ₎La₃Zr₂Ga_{b}O₁₂, M₍₇₋ₐ₎La₃Zr_{(2-b)}Ta_{b}O₁₂, and M₍₇₋ₐ₎La₃Zr_{(2-b)}Nb_{b}O₁₂);
MLTaO (for example, M₇La₃Ta₂O₁₂, M₅La₃Ta₂O₁₂, and M₆La₃Ta_{1.5}Y_{0.5}O₁₂);
MLSnO (for example, M₇La₃Sn₂O₁₂);
MAGP (for example, M₁₊ₐAlₐGe₂₋ₐ(PO₄)₃);
MATP (for example, M₁₊ₐAlₐTi₂₋ₐ(PO₄)₃);
MLTiO (for example, M₃ₐLa_{(2/3-a)}TiO₃);
MZP (for example, MₐZn_{b}(PO₄)_{c});
MCZP (for example, MₐCa_{b}Zr_{c}(PO₄)_{d});
MGPS (for example, MₐGe_{b}P_{c}S_{d} such as M₁₀GeP₂S₁₂);
MGPSO (for example, MₐGe_{b}P_{c}S_{d}Oₑ);
MSiPS (for example, MₐSi_{b}P_{c}S_{d} such as M₁₀SiP₂S₁₂);
MSiPSO (for example, MₐSi_{b}P_{c}S_{d}Oₑ);
MSnPS (for example, MₐSn_{b}P_{c}S_{d} such as M₁₀SnP₂S₁₂);
MSnPSO (for example, MₐSn_{b}P_{c}S_{d}Oₑ);
MPS (for example, MₐP_{b}S_{c} such as M₇P₃S₁₁);
MPSO (for example, MₐP_{b}S_{c}O_{d});
MZPS (for example, MₐZn_{b}P_{c}S_{d});
MZPSO (for example, MₐZn_{b}P_{c}S_{d}Oₑ);
xM₂S-yP₂S₅;
xM₂S-yP₂S₅-zMX;
xM₂S-yP₂S₅-zP₂O₅;
xM₂S-yP₂S₅-zP₂O₅-wMX;
xM₂S-yM₂O-zP₂S₅;
xM₂S-yM₂O-zP₂S₅-wMX;
xM₂S-yM₂O-zP₂S₅-wP₂O₅;
xM₂S-yM₂O-zP₂S₅-wP₂O₅-yMX;
xM₂S-ySiS₂;
MPSX (for example, MₐP_{b}S_{c}X_{d} such as M₇P₃S₁₁X, M₇P₂S₈X, and M₆PS₅X);
MPSOX (for example, MₐP_{b}S_{c}O_{d}Xₑ);
MGPSX (for example, MₐGe_{b}P_{c}S_{d}Xₑ);
MGPSOX (for example, MₐGe_{b}P_{c}S_{d}O_{d}Xₑ);
MSiPSX (for example, MₐSi_{b}P_{c}S_{d}Xₑ);
MSiPSOX (for example, MₐSi_{b}P_{c}S_{d}OₑX_{f});
MSnPSX (for example, MₐSn_{b}P_{c}S_{d}Xₑ);
MSnPSOX (for example, MₐSn_{b}P_{c}S_{d}OₑX_{f});
MZPSX (for example, MₐZn_{b}P_{c}S_{d}Xₑ);
MZPSOX (for example, MₐZn_{b}P_{c}S_{d}OₑX_{f});
M₃OX;
M₂HOX;
M₃PO₄;
M₃PS₄; and
MₐPO_{b}N_{c} (where a=2b+3c−5),
wherein,
M is an alkali metal ion, an alkaline earth metal ion, or a combination thereof, and wherein when M comprises an alkaline earth metal ion, then the number of M is adjusted to achieve electroneutrality, preferably M is selected from Li, Na, K, Rb, Cs, Be, Mg, Ca, Sr, Ba, or a combination of at least two thereof, and more preferably M is Li:
X is selected from F, Cl, Br, I, or a combination of at least two thereof,
a, b, c, d, e, and f are numbers other than zero and are, independently in each formula, selected to achieve electroneutrality; and
v, w, x, y, and z are numbers other than zero and are, independently in each formula, selected to obtain a stable compound;
(vi) the additive is selected from inorganic argyrodite-type compounds of formula Li₆PS₅X, wherein X is Cl, Br, I, or a combination thereof, or
(vii) the additive is Li₆PS₅Cl. selected to achieve electroneutrality; and

56-64. (canceled)

65. The electrode material of claim 31, further comprising a binder.

66. The electrode material of claim 65, wherein the binder is selected from the group consisting of a polyether, polycarbonate, or polyester type, a fluorinated polymer, and a water-soluble binder.

67. The electrode material of claim 65, wherein the binder comprises a blend of a polybutadiene-based polymer and a polymer comprising norbornene-based monomer units derived from polymerization of a Formula II compound: 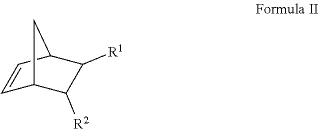
wherein,
R¹ and R² are independently and in each occurrence selected from a hydrogen atom, a carboxyl group (—COOH), a sulfonic acid group (—SO₃H), a hydroxyl group (—OH), a fluorine atom, and a chlorine atom, preferably R¹ and R² are independently and in each occurrence selected from a hydrogen atom and a —COOH group, and more preferably R¹ is a —COOH group and R² is a hydrogen atom or R¹ an R² are both —COOH groups.

68. The electrode material of claim 67, wherein the polymer is a polymer of Formula III: 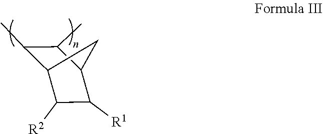
wherein,
R¹ and R² are as defined in claim 67; and
n is an integer selected so that the mass average molecular weight of the polymer of Formula III is between about 10 000 g/mol and about 100 000 g/mol, upper and lower limits included.

69-71. (canceled)

72. The electrode material of claim 67, wherein the polybutadiene-based polymer is polybutadiene or is selected from epoxidized polybutadienes.

73. (canceled)

74. The electrode material of claim 72, wherein the epoxidized polybutadiene comprises repeating units of Formulae IV, V, and VI: 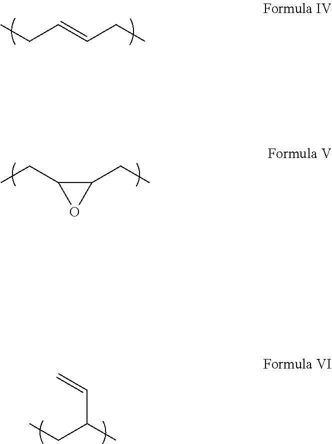
and two hydroxyl end groups.

75. The electrode material of claim 74, wherein the epoxidized polybutadiene is of Formula VII: 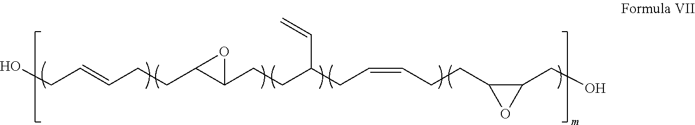
wherein,
m is an integer selected so that the mass average molecular weight of the epoxidized polybutadiene of Formula VII is between about 1 000 g/mol and about 1 500 g/mol, upper and lower limits included, and preferably the mass average molecular weight of the epoxidized polybutadiene of Formula VII is about 1 300 g/mol; and
the epoxide equivalent weight is between about 100 g/mol and about 600 g/mol, and preferably between about 210 g/mol and about 550 g/mol, upper and lower limits included.

76-77. (canceled)

78. The electrode material of claim 75, wherein the epoxidized polybutadiene of Formula VII is a Poly bd™ 600E resin having a mass average molecular weight of about 1 300 g/mol and an epoxide equivalent weight of between about 400 g/mol and about 500 g/mol, upper and lower limits included or is a Poly bd™ 605E resin having a mass average molecular weight of about 1 300 g/mol and an epoxide equivalent weight of between about 260 g/mol and about 330 g/mol, upper and lower limits included.

79. (canceled)

80. The electrode material of claim 67, wherein the weight ratio of polybutadiene-based polymer: polymer comprising norbornene-based monomer units derived from polymerization of the compound of Formula II is in the range from about 6:1 to about 2:3, upper and lower limits included, preferably the weight ratio is in the range of from about 5.5:1 to about 2:3, or from about 5:1 to about 2:3, or from about 4.5:1 to about 2:3, or from about 4:1 to about 2:3, or from about 6:1 to about 1:1, or from about 5.5:1 to about 1.1, or from about 5:1 to about 1:1, or from about 4.5:1 to about 1:1, or from about 4:1 to about 1:1, upper and lower limits included, and more preferably the weight ratio is in the range of from about 4:1 to about 1:1, upper and lower limits included.

81-82. (canceled)

83. An electrode comprising the electrode material as defined in claim 31, said electrode being a self-supported electrode or being on a current collector.

84.-85. (canceled)

86. An electrolyte comprising coated particles as defined in claim 16, wherein the core of the coated particle comprises an ionically conductive inorganic material, said electrolyte preferably being:
a liquid electrolyte comprising a salt in a solvent;
a solid polymer electrolyte comprising a salt in a solvating polymer;
a polymer-ceramic hybrid solid electrolyte; or
an inorganic solid electrolyte preferably being a ceramic-type inorganic solid electrolyte.

87. The electrolyte of claim 86, wherein:
(i) the ionically conductive inorganic material is selected from glasses, glass-ceramics, ceramics, nano-ceramics, and a combination of at least two thereof;
(ii) the ionically conductive inorganic material comprises a ceramic, a glass, or a glass-ceramic based on fluoride, phosphide, sulfide, oxysulfide, or oxide;
(iii) the ionically conductive inorganic material is selected from LISICON, thio-LISICON, argyrodite, garnet, NASICON, perovskite type compounds, oxides, sulfides, oxysulfides, phosphides, fluorides, in crystalline and/or amorphous form, and a combination of at least two thereof;
(iv) the ionically conductive inorganic material selected from inorganic compounds of formulae:
MLZO (for example, M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎La₃Zr_{(2-b)}Ta_{b}O₁₂ and M₍₇₋ₐ₎La₃Zr_{(2-b)}Nb_{b}O₁₂;
MLTaO (for example, M₇La₃Ta₂O₁₂, M₅La₃Ta₂O₁₂, and M₆La₃Ta_{1.5}Y_{0.5}O₁₂);
MLSnO (for example, M₇La₃Sn₂O₁₂);
MAGP (for example, M₁₊ₐAlₐGe₂₋ₐ(PO₄)₃);
MATP (for example, M₁₊ₐAlₐTi₂₋ₐ(PO₄)₃);
MLTiO (for example, M₃ₐLa_{(2/3-a)}TiO₃);
MZP (for example, MₐZr_{b}(PO₄)_{c});
MCZP (for example, MₐCa_{b}Zr_{c}(PO₄)_{d});
MGPS (for example, MₐGe_{b}P_{c}S_{d} such as M₁₀GeP₂S₁₂);
MGPSO (for example, MₐGe_{b}P_{c}S_{d}Oₑ);
MSiPS (for example, MₐSi_{b}P_{c}S_{d} such as M₁₀SiP₂S₁₂);
MSiPSO (for example, MₐSi_{b}P_{c}S_{d}Oₑ);
MSnPS (for example, MₐSn_{b}P_{c}S_{d} such as M₁₀SnP₂S₁₂);
MSnPSO (for example, MₐSn_{b}P_{c}S_{d}Oₑ);
MPS (for example, MₐP_{b}S_{c} such as M₇P₃S₁₁);
MPSO (for example, MₐP_{b}S_{c}O_{d});
MZPS (for example, MₐZn_{b}P_{c}S_{d});
MZPSO (for example, MₐZn_{b}P_{c}S_{d}Oₑ);
xM₂S-yP₂S₅;
xM₂S-yP₂S₅-zMX;
xM₂S-yP₂S₅-zP₂O₅;
xM₂S-yP₂S₅-zP₂O₅-wMX;
xM₂S-yM₂O-zP₂S₅;
xM₂S-yM₂O-zP₂S₅-wMX;
xM₂S-yM₂O-zP₂S₅-wP₂O₅;
xM₂S-yM₂O-zP₂S₅-wP₂O₅-vMX;
xM₂S-ySiS₂;
MPSX (for example, MₐP_{b}S_{c}X_{d} such as M₇P₃S₁₁X, M₇P₂S₈X, and M₆PS₅X);
MPSOX (for example, MₐP_{b}S_{c}O_{d}Xₑ);
MGPSX (for example, MₐGe_{b}P_{c}S_{d}Xₑ);
MGPSOX (for example, MₐGe_{b}P_{c}S_{d}OₑX_{f});
MSiPSX (for example, MₐSi_{b}P_{c}S_{d}Xₑ);
MSiPSOX (for example, MₐSi_{b}P_{c}S_{d}OₑX_{f});
MSnPSX (for example, MₐSn_{b}P_{c}S_{d}Xₑ);
MSnPSOX (for example, MₐSn_{b}P_{c}S_{d}OₑX_{f});
MZPSX (for example, MₐZn_{b}P_{c}S_{d}Xₑ);
MZPSOX (for example, MₐZn_{b}P_{c}S_{d}OₑX_{f});
M₃OX;
M₂HOX;
M₃PO₄;
M₃PS₄; and
MₐPO_{b}N_{c} (where a=2b+3c−5);
wherein,
M is an alkali metal ion, an alkaline earth metal ion, or a combination thereof, and wherein when M comprises an alkaline earth metal ion, then the number of M is adjusted to achieve electroneutrality, preferably M is selected from Li, Na, K, Rb, Cs, Li;
X is selected F, Cl, Br, I, or a combination of at least two thereof;
a, b, c, d, e, and f are numbers other than zero and are, independently in each formula, selected to achieve electroneutrality; and
y, w, x, y, and z are numbers other than zero and are, independently in each formula, selected to obtain a stable compound;
(v) the ionically conductive inorganic material is selected from argyrodite-type inorganic compounds of formula Li₆PS₅X, wherein X is Cl, Br, I, or a combination of at least two thereof; or
(vi) the ionically conductive inorganic material is Li₆PS₅Cl.

88-99. (canceled)

100. A coating material for a current collector comprising coated particles as defined in claim 16, wherein the core of the coated particle comprises an electronically conductive material, preferably the electronically conductive material is carbon.

101. (canceled)

102. A current collector comprising a coating material as defined in claim 100 disposed on a metallic foil.

103. An electrochemical cell comprising a negative electrode, a positive electrode, and an electrolyte, wherein at least one of the positive electrode or the negative electrode is as defined in claim 83.

104. An electrochemical cell comprising a negative electrode, a positive electrode, and an electrolyte, wherein the electrolyte is as defined in claim 86.

105. An electrochemical cell comprising a negative electrode, a positive electrode, and an electrolyte, wherein at least one of the positive electrode and the negative electrode is on a current collector as defined in claim 102.

106. The electrochemical cell of claim 104, wherein:
the negative electrode comprises an electrochemically active material comprising an alkali metal, an alkaline earth metal, an alloy comprising at least one alkali or alkaline earth metal, a non-alkali and non-alkaline earth metal, or an intermetallic alloy or compound, and preferably the electrochemically active material of the negative electrode comprises metallic lithium or an alloy including or based on metallic lithium, wherein the electrochemically active material of the negative electrode is preferably in the form of a film having a thickness in the range of from about 5 μm to about 500 μm, upper and lower limits included, and more preferably the thickness of the film of the electrochemically active material of the negative electrode is in the range of from about 10 μm to about 100 μm, upper and lower limits included; or
the positive electrode is pre-lithiated and the negative electrode is substantially free of lithium, and preferably the negative electrode is lithiated in situ during the cycling of said electrochemical cell.

107-111. (canceled)

112. An electrochemical accumulator comprising at least one electrochemical cell as defined in claim 103, wherein said electrochemical accumulator is a battery selected from a lithium battery, a lithium-ion battery, a sodium battery, a sodium-ion battery, a magnesium battery, a magnesium-ion battery, preferably said battery is a lithium battery or a lithium-ion battery, and preferably wherein said electrochemical accumulator is an all-solid-state battery.

113-115. (canceled)

116. An electrochemical accumulator comprising at least one electrochemical cell as defined in claim 104, wherein said electrochemical accumulator is a battery selected from a lithium battery, a lithium-ion battery, a sodium battery, a sodium-ion battery, a magnesium battery, and a magnesium-ion battery, preferably said battery is a lithium battery or a lithium-ion battery, and preferably wherein said electrochemical accumulator is an all-solid-state battery.

117. An electrochemical accumulator comprising at least one electrochemical cell as defined in claim 105, wherein said electrochemical accumulator is a battery selected from a lithium battery, a lithium-ion battery, a sodium battery, a sodium-ion battery, a magnesium battery, and a magnesium-ion battery, preferably said battery is a lithium battery or a lithium-ion battery, and preferably wherein said electrochemical accumulator is an all-solid-state battery.
